(19) United States
(12) Patent Application Publication
(10) Pub. No.: US 2011/0207637 A1
(43) Pub. Date: Aug. 25, 2011

(54) Vicinally Disubstituted Internal Olefins as Constituents of Olefin Copolymers for Lubricating Oil Rheology Modifiers

(76) Inventors: Sudhin Datta, Houston, TX (US); Smita Kacker, Katy, TX (US); Mun F. Tse, Seabrook, TX (US); Thomas T. Sun, Clinton, NJ (US); Eric B. Sirota, Flemington, NJ (US); Vera Minak-Bernero, Bridgewater, NJ (US); Liehpao O. Farng, Lawrenceville, NJ (US)

(21) Appl. No.: 12/980,690

(22) Filed: Dec. 29, 2010

Related U.S. Application Data
(60) Provisional application No. 61/306,246, filed on Feb. 19, 2010.

(51) Int. Cl. C10M 143/02; C08F 210/02; C08F 230/08; C08F 210/08; C08F 210/14; C10M 155/02

(52) U.S. Cl. 508/207; 526/348; 526/279; 526/348.6; 526/348.4; 526/348.2; 526/348.3; 508/591

(57) ABSTRACT

This invention relates to an ethylene copolymer for lubricating oil, comprising: ethylene; at least one alpha-olefin having 3 or more carbon atoms; and at least one vicinally substituted olefin having 2 to 40 carbon atoms, wherein: the copolymer has a weight-average molecular weight (Mw) of about 50,000 to about 500,000; and an intensity ratio of S_{αβ} to S_{αα} insertions, as determined by a ¹³C-NMR spectrum of less than 0.5.

### PRIORITY CLAIM

This application claims priority to and the benefit of U.S. Ser. No. 61/306,246, filed Feb. 19, 2010, the disclosure of which is incorporated herein by reference in its entirety.

### FIELD OF THE INVENTION

Embodiments provided herein generally relate to methods and compositions for improved viscosity lube oils. More particularly, embodiments provided herein relate to viscosity modifiers for lubricating oils and methods for making same.

### BACKGROUND OF THE INVENTION

Lubricant oil formulations generally contain viscosity index (VI) improving components to modify the rheological behavior to increase the lubricant viscosity, and promote a more constant viscosity over a range of temperatures over which the lubricant is used. The VI has been used to measure the rate of change of viscosity of a fluid in relation to temperature. In general, the higher the VI, the smaller the relative change in viscosity with temperature. A VI improver or viscosity modifier has been used to reduce the temperature dependency of the viscosity of the lubricant compositions so that the lubricant compositions can be used over a wide temperature range. In other words, VI improvers prevent the lubricant compositions from becoming too thin at a high temperature, e.g., hot summer temperatures, and too viscous at a low temperature, e.g., cold winter temperatures. Some known VI improvers include polymethacrylates, olefin copolymers, such as ethylene-propylene copolymers and ethylene-propylene diene-modified copolymers (EPDMs), and hydrogenated styrenic block copolymers such as styrene-ethylene/butylene-styrene copolymer (SEBS).

In recent years, ethylene/α-olefin copolymers have been used as viscosity modifiers, exhibiting the effect of improving viscosity index for the purpose of decreasing the temperature dependence of the lubricant's viscosity. See, for example, U.S. Pat. Nos. 6,589,920; 5,391,617; 7,053,153; and 5,374,700. Higher ethylene-content copolymers efficiently promote oil thickening, shear stability, and low temperature viscometrics, while lower ethylene-content copolymers are added for the purpose of lowering the oil pour point.

Blends of amorphous and semicrystalline ethylene propylene copolymers have also been used for lubricant oil formulations. The combination of two such ethylene-propylene copolymers allows for increased thickening efficiency, shear stability, low temperature viscosity performance, and pour point. See, for example, U.S. Pat. No. 5,391,617 and EP 0 638 611.

Heretofore the use of conventional vanadium based Ziegler-Natta catalysts made it possible to polymerize polymers of ethylene and propylene only. Polymers suitable for use as viscosity modifiers composed of these monomers contained some fraction (typically 5 mole %) of the propylene residues in a 2,1 insertion pattern while the remainder of the propylene units had a more normal 1,2 insertion system. This difference in the insertion procedures could be easily accounted for by the number of methylene carbon atoms (CH₂) in each sequence, inside the polymer chain, between the methine carbon atoms (CH) emanating from the insertion of propylene. In a polymer with exclusively a 1,2 insertion, all of the sequences of methylene carbon atoms are odd, while in a polymer with a mixture of a majority of 1,2 insertions and a minority fraction of 2,1 insertions, a portion, which is approximately twice the fraction of the 2,1 insertions, of the methylene sequences are even.

In developments of the metallocene polymerization, which are significantly more versatile and more capable in polymerizing monomers other than ethylene and propylene, it has been noted that they invariably tend to have a much lower tendency to incorporate propylene in a 2,1 manner compared to traditional Ziegler Natta catalysts referred to earlier. This has been noted in U.S. Pat. Nos. 6,525,007 and 5,446,221; which are incorporated herein by reference. This tendency to incorporate propylene in defined 1,2 orientation occurs for metallocene polymers made both in solution as well as in bulk and gas phase processes and appears inherent to the ability of this family of catalysts. Based on the earlier discussion, it would appear that the presence of such as predominant mode of insertion of propylene would lead to, in ethylene propylene polymers, a notable lack of diversity or distribution of the number of methylene carbon atoms in contiguous sequences in that the majority of them would be numerically odd. It is postulated that such a predominant microstructure of the polymer chain would lead to improved crystallinity at lower ethylene contents and thus a comparative absence of fluidity of solutions of these polymers when used as motor oils at low temperatures. These concerns have been raised in the art and no satisfactory solution, except in the synthesis of a completely new composition of polymers, as in Mitsui EP 1 300 458 B1, has been obtained so far.

Higher molecular weight copolymers of ethylene and vicinally disubstituted olefins are disclosed in U.S. Pat. No. 7,037,989.

There is still a need, therefore, for new VI improvers or viscosity modifiers to reduce the temperature dependency of the viscosity of the lubricant compositions with improved low temperature performance and for lubricant compositions that can be used over a wide range of temperatures.

### SUMMARY OF THE INVENTION

This invention relates to an ethylene copolymer for lubricating oil, comprising: ethylene; at least one alpha-olefin having 3 or more carbon atoms; and at least one vicinally substituted olefin having 2 to 40 carbon atoms; wherein: the copolymer has a weight-average molecular weight (Mw) of about 50,000 to about 500,000; and an intensity ratio of S_{αβ} to S_{αα} insertions, as determined by a ¹³C-NMR spectrum of less than 0.5.

### DETAILED DESCRIPTION OF THE INVENTION

When a polymer is referred to as comprising a monomer (such as olefin), the monomer present in the polymer is the polymerized form of the monomer. The term polymer is meant to encompass homopolymers and copolymers. The term copolymer includes any polymer having two or more different monomers in the same chain, and encompasses random copolymers, statistical copolymers, interpolymers, and (true) block copolymers. In the context of this document, “homopolymerization” would produce a polymer made from one monomer and “copolymerization” would produce polymers with more than one monomer type. Copolymerization can also incorporate α-olefinic macromonomers of up to 2000 mer units. Also, an ethylene polymer (also referred to as polyethylene) is a homopolymer of ethylene or a copolymer having at least 50 wt % ethylene (preferably at least 60 wt %, preferably at least 70 wt %, preferably at least 80 wt %), based on the weight of the polymer. Also a propylene polymer (also referred to as polypropylene) is a homopolymer of propylene or a copolymer having at least 50 wt % propylene (preferably at least 60 wt %, preferably at least 70 wt %, preferably at least 80 wt %), based on the weight of the polymer.

This invention relates to ethylene copolymers possessing irregularity in the insertion of the ethylene residues, in sequences of both odd and even lengths. Such irregularity leads to a lower level of crystallinity as well as the formation of weaker and smaller ethylene crystallites. Not wishing to be bound by theory, it is believed that such an ethylene polymer would have, as a VI improver for motor oils, significantly better low temperature fluidity than VI improvers made of a polymer where the ethylene sequences were all odd.

The polymers disclosed herein are ethylene-alpha-olefin (EaO) copolymers having certain 2,1 insertion patterns. This may be achieved by: 1) insertion of a monomer having an internal double bond (such as a vicinally substituted monomer as described below) into the growing EaO chain; 2) insertion of a cyclic olefin into the growing EaO chain; 3) insertion of a polyene into the growing EaO chain; and/or 4) selection of polymerization catalyst system(s) and/or polymerization conditions to promote certain 2,1 insertions.

Preferably, the polymers disclosed herein are ethylene-propylene (EP) copolymers having certain 2,1 insertion patterns. This may be achieved by: 1) insertion of a monomer having an internal olefin (such as a vicinally substituted monomer as described below) into the growing EP chain; 2) insertion of a cyclic olefin into the growing EP chain; 3) insertion of a polyene into the growing EP chain; and/or 4) selection of polymerization catalyst system(s) and/or polymerization conditions to promote certain 2,1 insertions.

### Alpha-Olefins

Any alpha-olefin having 3 or more carbon atoms can be used in the ethylene copolymers described herein. The alpha-olefin comonomer can be linear or branched, and two or more alpha-olefins can be used, if desired. Thus, reference herein to “an alpha-olefin comonomer” includes one, two, or more alpha-olefin comonomers. Suitable alpha-olefins include, but are not limited to, propylene, linear C₄-C₁₂ alpha-olefins, and alpha-olefins having one or more C₁-C₃ alkyl branches. Specific examples include propylene; 1-butene; 3-methyl-1-butene; 3,3-dimethyl-1-butene; 1-pentene; 1-pentene with one or more methyl, ethyl or propyl substituents; 1-hexene, 1-hexene with one or more methyl, ethyl or propyl substituents; 1-heptene, 1-heptene with one or more methyl, ethyl or propyl substituents; 1-octene, 1-octene with one or more methyl, ethyl or propyl substituents; 1-nonene, 1-nonene with one or more methyl, ethyl or propyl substituents; ethyl, methyl or dimethyl-substituted 1-decene, or 1-dodecene. Preferred alpha-olefin comonomers include propylene, 1-butene, 1-pentene, 3-methyl-1-butene, 1-hexene, 3-methyl-1-pentene, 4-methyl-1-pentene, 3,3-dimethyl-1-butene, 1-heptene, 1-hexene with a methyl substituents on C₃, C₄, or C₅, 1-pentene with two methyl substituents in any stoichiometrically acceptable combination on C₃ or C₄, 1-octene, 1-pentene with a methyl substituents on any of C₃ or C₄, 1-hexene with two methyl substituents in any stoichiometrically acceptable combination on C₃, C₄, and/or C₅, 1-pentene with three methyl substituents in any stoichiometrically acceptable combination on C₃ and/or C₄, 1-hexene with an ethyl substituents on C₃ or C₄, 1-pentene with an ethyl substituents on C₃ and a methyl substituents in a stoichiometrically acceptable position on C₃ or C₄, 1-decene, 1-nonene with a methyl substituents on any of C₃, C₄, C₅, C₆, C₇, C₈, or C9, 1-octene with two methyl substituents in any stoichiometrically acceptable combination on C₃, C₄, C₅, C₆, and/or C₇, 1-heptene with three methyl substituents in any stoichiometrically acceptable combination on C₅ and/or C₆, 1-octene with an ethyl substituents on any of C₃, C₄, C₅, C₆, or C₇, 1-hexene with two ethyl substituents in any stoichiometrically acceptable combination on C₃ and/or C₄, and 1-dodecene.

### Internal Olefin

Internal olefins (also referred to as internal double bonds) useful herein include any one or more vicinally substituted olefins, typically a vicinally disubstituted olefin. Any vicinally substituted olefin or “internal olefin” that is capable of producing an ethylene polymer with a controlled population of even and odd ethylene sequences can be used herein. Preferably, the internal olefin(s) are incorporated in the minority, i.e., less than 50 wt %, based on total weight percent of the ethylene-olefin (EaO) copolymer (preferably the internal olefin is incorporated into the EaO copolymer at from 1 wt % to 40 wt %, preferably at from 3 wt % to 20 wt %, preferably 5 wt % to 10 wt % based upon the weight of the EaO copolymer). Preferably, the internal olefin includes one or more vicinally disubstituted olefins described by the formula: (R¹)CH═CH(R²), where R¹ and R² may independently include one or more hydrocarbyl or silyl-hydrocarbyl groups containing one or more carbon or silicon atoms, or may be linear, branched or cyclic substituted or unsubstituted hydrocarbyl or silyl-hydrocarbyl groups having from 1-100 carbon or silicon atoms, or they may contain 30 or less carbon or silicon atoms; however, R¹ and R² may generally be independently hydrocarbyl or silyl-hydrocarbyl, the inclusion of non-carbon or -silicon atoms, such as for example B, O, S, Se, Te, N, P, Ge, Sn, Pb, As, F, Cl, Br, or I, are contemplated, where such non-carbon or -silicon moieties are sufficiently far removed from the double bond so as not to interfere with the coordination polymerization reaction with the catalyst and so to retain the generally hydrocarbyl characteristic. By sufficiently far removed from the double bond, we intend that the number of carbon atoms, or the number of carbon and silicon atoms, separating the double bond and the non-carbon or -silicon moiety may be 6 or greater, e.g., 7, or 8, or 9, or 10, or 11, or 12, or 13, or 14, or more. The number of such carbon atoms, or carbon and silicon atoms, is counted from immediately adjacent to the double bond to immediately adjacent to the non-carbon or -silicon moiety. Non-limiting examples of vicinally disubstituted olefins comprise, cis and/or trans (and/or E and/or Z) isomers of 2-butene, 2-pentene, 2-hexpyel 3-hexene, 2-heptene, 3-heptene, 2-octene, 3-octene, 4-octene, 2-nonene, 3-nonene, 4-nonene, 2-decene, 3-decene, 4-decene, 5-decene, 2-undecene, 3-undecene, 4-undecene, 5-undecene, 2-dodecene, 3-dodecene, 4-dodecene, 5-dodecene, 6-dodecene, 2-tridecene, 3-tridecene, 4-tridecene, 5-tridecene, 6-tridecene, 2-tetradecene, 3-tetradecene, and 4-tetradecene. Other useful internal olefins include cyclic olefins such as cyclopentene, cyclohexene, and norbornene.

Particularly, preferred internal olefins include olefins represented by the formula (R*)CH═CH(R*), where each R* has, independently, 1 to 30 carbon atoms, preferably 1 to 20 carbon atoms, preferably 1 to 12 carbon atoms. In a preferred embodiment, the internal olefin is 2-butene, and more preferably cis-2-butene.

A list of additional internal olefins useful herein is located in U.S. Pat. No. 7,037,989 at Column 8, line 53 to Column 12, line 37, incorporated by reference.

Vicinally disubstituted olefins, for the purposes of this specification, do not include cyclic olefins wherein the olefinic group is entirely within a cyclic structure, for example, cyclopentene or cyclohexene.

In another embodiment, the copolymers described herein are substantially free of geminally disubstituted olefins. By substantially free of, is meant 5 mole % or less, ≦3 mole %, ≦1 mole %, ≦0.5 mole %, ≦0.1 mole %, or none intentionally added, or none detectable by currently available techniques (NMR). Geminally disubstituted olefins include isobutylene, 3-trimethylsilyl-2-methyl-1-propene, 2-methyl-1-butene, 2-methyl-1-pentene, 2-ethyl-1-pentene, 2-methyl-1-hexene, 2-methyl-1-heptene, 6-di methylamino-2-methyl-1-hexene, or α-methylstyrene as representative compounds, or other moieties as described in U.S. Pat. No. 5,866,665 (at Column 5, lines 3-29), incorporated herein by reference. A geminally disubstituted olefin is an olefin having the generic formula R₁═R₂(R₃)(R₄), where R₁ is CH₂, R₂ is C, and R₃ and R₄ are, independently, hydrocarbyl groups or substituted hydrocarbyl groups containing at least one carbon atom bound to R₂. Preferably, R₃ and R₄ are linear, branched or cyclic, substituted or unsubstituted, hydrocarbyl groups having from 1 to 100 carbon atoms, preferably 30 or less carbon atoms, and optionally R₃ and R₄ are connected to form a cyclic structure.

### Polyenes and Cyclic Olefins

The term “polyene,” as used herein, is meant to include monomers having two or more unsaturations, i.e., dienes, trienes, etc. Polyenes particularly useful as co-monomers are non-conjugated dienes, preferably are straight chain, hydrocarbon di-olefins or cycloalkenyl-substituted alkenes, having about 6 to about 15 carbon atoms, for example: (a) straight chain acyclic dienes, such as 1,4-hexadiene and 1,6-octadiene; (b) branched chain acyclic dienes, such as 5-methyl-1,4-hexadiene, 3,7-dimethyl-1,6 heptadiene; (c) single ring alicyclic dienes, such as 1,4-cyclohexadiene, 1,5-cyclo-octadiene and 1,7-cyclododecadiene; (d) multi-ring alicyclic fused and bridged ring dienes, such as tetrahydroindene; norbornadiene; methyl-tetrahydroindene; dicyclopentadiene (DCPD); bicyclo(2.2.1)-hepta-2,5-diene; alkenyl, alkylidene, cycloalkenyl and cycloalkylidene norbornenes, such as 5-methylene-2-norbornene (MNB), 5-propenyl-2-norbornene, 5-isopropylidene-2-norbornene, 5-(4-cyclopenteny-2-norbornene, 5-cyclohexylidene-2-norbornene, and 5-vinyl-2-norbornene (VNB); (e) cycloalkenyl-substituted alkenes, such as vinyl cyclohexene, allyl cyclohexene, vinyl cyclooctene, 4-vinyl cyclohexene, allyl cyclodecene; and (f) vinyl cyclododecene. Of the non-conjugated dienes typically used, the preferred dienes are dicyclopentadiene (DCPD), 1,4-hexadiene, 1,6-octadiene; 5-methyl-1,4-hexadiene; 3,7-dimethyl-1,6-octadiene; 5-methylene-2-norbornene, 5-ethylidene-2-norbornene (ENB), and tetracyclo (Δ11,12) 5,8 dodecene. Example of non-conjugated dienes may be found in U.S. Pat. No. 5,610,254; incorporated herein by reference.

Note that throughout this application the terms “polyene,” “non-conjugated diene,” and “diene” are used interchangeably. It is preferred to use dienes, which do not lead to the formation of long chain branches. For successful use as VI improver non- or lowly branched polymer chains are preferred. Other polyenes that may be used, include cyclopentadiene and octatetra-ene.

### Cyclic Olefin

The cyclic olefin is defined to be a mono-olefin where the polymerizable double bond of the olefin is a part of at least one carboxylic ring structure. Typically, the polymer contains 0.5 mole % to 10 mole %, preferably 1 mole % to 7 mole % of the cyclic olefin, preferably 4 mole % to 8 mole %. The synthesis of polymers containing cyclic olefins has been widely described in the art. Synthesis using Ziegler-Natta vanadium catalysts have been described in Canadian Patent 920742 issued Feb. 6, 1973 and assigned to DuPont; in U.S. Pat. No. 5,179,171 issued Jan. 12, 1993 and assigned to Mitsui Petrochemical; and in U.S. Pat. No. 5,225,503 issued Jul. 6, 1993 and assigned to Mitsui Petrochemical. Synthesis using metallocene catalysts may also be practiced and has been described in International Patent Application PCT/US94/00642 on Aug. 4, 1994.

### Catalyst Compounds

For the purposes of this invention and the claims thereto, when a polymer is referred to as comprising an olefin, the olefin present in the polymer is the polymerized form of the olefin. Likewise, when catalyst components are described as comprising neutral stable forms of the components, it is well understood by one of ordinary skill in the art, that the ionic form of the component is the form that reacts with the monomers to produce polymers. In addition, a reactor is any container(s) in which a chemical reaction occurs.

As used herein, the new numbering scheme for the Periodic Table Groups are used as in CHEMICAL AND ENGINEERING NEWS, 63(5), 27 (1985).

The polymers described herein can be made in the presence of a transition metal metallocene precatalyst (alternatively referred to herein as a catalyst compound, a metallocene catalyst compound, a catalyst or a catalyst component, which, together with an activator, comprise a catalyst system).

In a preferred embodiment, the catalyst compound is represented by the formula:

L^{A}L^{B}MQ*ₙ (1) or

L^{A}A*L^{B}MQ*ₙ (2)

where M is a metal atom from the Periodic Table of the Elements and may be a Group 3 to 12 metal or from the lanthanide or actinide series of the Periodic Table of Elements, preferably M is a Group 4, 5, or 6 transition metal, more preferably M is a Group 4 transition metal, even more preferably M is zirconium, hafnium, or titanium. The bulky ligands, L^{A} and L^{B}, are open, acyclic or fused ring(s) or ring system(s), and are any ancillary ligand system, including unsubstituted or substituted, cyclopentadienyl ligands or cyclopentadienyl-type ligands, heteroatom substituted and/or heteroatom containing cyclopentadienyl-type ligands. Non-limiting examples of bulky ligands include cyclopentadienyl ligands, cyclopentaphenanthreneyl ligands, indenyl ligands, benzindenyl ligands, fluorenyl ligands, dibenzo[b,h]fluorenyl ligands, benzo[b]fluorenyl ligands, cyclooctatetraendiyl ligands, cyclopentacyclododecene ligands, azenyl ligands, azulene ligands, pentalene ligands, phosphoyl ligands, phosphinimine, pyrrolyl ligands, pyrozolyl ligands, carbazolyl ligands, boratobenzene ligands and the like, including hydrogenated versions thereof, for example tetrahydroindenyl ligands. In one embodiment, L^{A} and L^{B} may be any other ligand structure capable of π-bonding to M. In yet another embodiment, the atomic molecular weight (MW) of L^{A} or L^{B} exceeds 60 a.m.u., preferably greater than 65 a.m.u. In another embodiment, L^{A} and L^{B} may comprise one or more heteroatoms, for example, nitrogen, silicon, boron, germanium, sulfur and phosphorous, in combination with carbon atoms to form an open, acyclic, or preferably, a fused, ring or ring system, for example, a hetero-cyclopentadienyl ancillary ligand. Other L^{A} and L^{B} bulky ligands include but are not limited to bulky amides, phosphides, alkoxides, aryloxides, imides, carbolides, borollides, porphyrins, phthalocyanines, corrins, and other polyazomacrocycles. Independently, each L^{A} and L^{B} may be the same or different type of bulky ligand that is bonded to M. In one embodiment of Formula 1 only one of either L^{A} or L^{B} is present.

Independently, each L^{A} and L^{B} may be unsubstituted or substituted with a combination of substituent groups R*. Non-limiting examples of substituent groups R* include one or more from the group selected from hydrogen, or linear, or branched alkyl radicals, alkenyl radicals, alkynyl radicals, cycloalkyl radicals, aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl-carbamoyl radicals, acyloxy radicals, acylamino radicals, aroylamino radicals or combination thereof. In a preferred embodiment, substituent groups R* have up to 50 non-hydrogen atoms, preferably from 1 to 30 carbon, that may also be substituted with halogens or heteroatoms or the like. Non-limiting examples of alkyl substituents R* include methyl, ethyl, propyl, butyl, pentyl, hexyl, cyclopentyl, cyclohexyl, benzyl or phenyl groups and the like, including all their isomers, for example tertiary butyl, isopropyl, and the like. Other hydrocarbyl radicals include fluoromethyl, fluoroethyl, difluoroethyl, iodopropyl, bromohexyl, chlorobenzyl and hydrocarbyl substituted organometalloid radicals including trimethylsilyl, trimethylgermyl, methyldiethylsilyl and the like; and halocarbyl-substituted organometalloid radicals including tris(trifluoromethyl)silyl, methyl-bis(difluoromethyl)silyl, bromomethyldimethylgermyl and the like; and disubstituted boron radicals including dimethylboron for example; and disubstituted pnictogen radicals including dimethylamine, dimethylphosphine, diphenylamine, methylphenylphosphine, chalcogen radicals including methoxy, ethoxy, propoxy, phenoxy, methylsulfide and ethylsulfide. Non-hydrogen substituents R* include the atoms carbon, silicon, boron, aluminum, nitrogen, phosphorous, oxygen, tin, sulfur, germanium and the like, including olefins, such as, but not limited to, olefinically unsaturated substituents including vinyl-terminated ligands, for example, but-3-enyl, prop-2-enyl, hex-5-enyl and the like. Also, at least two R* groups, preferably two adjacent R groups, are joined to form a ring structure having from 3 to 30 atoms selected from carbon, nitrogen, oxygen, phosphorous, silicon, germanium, aluminum, boron or a combination thereof. Also, a substituent group, R*, may also be a diradical bonded to L at one end and forming a carbon sigma bond to the metal M. Other ligands may be bonded to the metal M, such as at least one leaving group Q*. In one embodiment, Q* is a monoanionic labile ligand having a sigma-bond to M. Depending on the oxidation state of the metal, the value for n is 0, 1, or 2 such that Formula 1 above represents a neutral bulky ligand metallocene catalyst compound. Non-limiting examples of Q* ligands include weak bases, such as amines, phosphines, ethers, carboxylates, dienes, hydrocarbyl radicals having from 1 to 20 carbon atoms, hydrides or halogens and the like or a combination thereof. In another embodiment, two or more Q*'s form a part of a fused ring or ring system. Other examples of Q* ligands include those substituents for R*, as described above, and including cyclobutyl, cyclohexyl, heptyl, tolyl, trifluoromethyl, tetramethylene (both Q*), pentamethylene (both Q*), methylidene (both Q*), methoxy, ethoxy, propoxy, phenoxy, bis(N-methylanilide), dimethylamide, dimethylphosphide radicals and the like.

Non-limiting examples of bridging group A* include bridging groups containing at least one Group 13 to 16 atom, often referred to as a divalent moiety, such as, but not limited to, at least one of a carbon, oxygen, nitrogen, silicon, aluminum, boron, germanium and tin atom or a combination thereof. Preferably, bridging group A* contains a carbon, silicon or germanium atom, most preferably, A* contains at least one silicon atom or at least one carbon atom. The bridging group A* may also contain substituent groups R* as defined above including halogens and iron. Non-limiting examples of bridging group A* may be represented by R′₂C, R′₂CCR′₂, R′₂Si, R′₂SiCR′₂, R′₂SiSiR′₂, R′₂Ge, R′P, R′N, R′B where R′ is independently, a radical group which is hydride, hydrocarbyl, substituted hydrocarbyl, halocarbyl, substituted halocarbyl, hydrocarbyl-substituted organometalloid, halocarbyl-substituted organometalloid, disubstituted boron, disubstituted pnictogen, substituted chalcogen, or halogen or two or more R′ may be joined to form a ring or ring system. In one embodiment, the bridged, bulky ligand metallocene catalyst compounds of Formula 2 have two or more bridging groups A* (EP 664 301 B1). In another embodiment, the bulky ligand metallocene catalyst compounds are those where the R* substituents on the bulky ligands L^{A} and L^{B} of Formulas 1 and 2 are substituted with the same or different number of substituents on each of the bulky ligands. In another embodiment, the bulky ligands L^{A} and L^{B} of Formulas 1 and 2 are different from each other.

In another embodiment, the catalyst composition useful herein is a metallocene catalyst compounds represented by Formula 3:

L^{C}A*J*MQ*ₙ (3)

where M is a Group 3 to 16 metal atom or a metal selected from the Group of actinides and lanthanides of the Periodic Table of Elements, preferably, M is a Group 3 to 12 transition metal, and more preferably, M is a Group 4, 5 or 6 transition metal, and most preferably, M is a Group 4 transition metal in any oxidation state, and is especially titanium; L^{C} is a substituted or unsubstituted bulky ligand bonded to M; J* is bonded to M; A* is bonded to J* and L^{C}; J* is a heteroatom ancillary ligand; and A* is a bridging group; Q* is a univalent anionic ligand; and n is the integer 0, 1, or 2. In Formula 3 above, L^{C}, A* and J* form a fused ring system. In an embodiment, L^{C} of Formula 3 is as defined above for L^{A}. A*, M and Q* of Formula 3 are as defined above for Formula 1 and 2. In Formula 3, J* is a heteroatom containing ligand in which J* is an element with a coordination number of three from Group 15 or an element with a coordination number of two from Group 16 of the Periodic Table of Elements. Preferably, J* contains a nitrogen, phosphorus, oxygen or sulfur atom with nitrogen being most preferred. In an embodiment of the invention, the bulky ligand metallocene catalyst compounds are heterocyclic ligand complexes where the bulky ligands, the ring(s) or ring system(s), include one or more heteroatoms or a combination thereof. Non-limiting examples of heteroatoms include a Group 13 to 16 element, preferably, nitrogen, boron, sulfur, oxygen, aluminum, silicon, phosphorous and tin. Examples of these bulky ligand metallocene catalyst compounds are described in WO 96/33202; WO 96/34021; WO 97/17379; WO 98/22486; EP-A1-0 874 005; U.S. Pat. Nos. 5,637,660; 5,539,124; 5,554,775; 5,756,611; 5,233,049; 5,744,417; and 5,856,258; all of which are herein incorporated by reference.

In preferred embodiment, the catalyst compound is represented by the general formula:

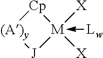

wherein:

M comprises Zr, Hf or Ti;

Cp comprises a cyclopentadienyl ring which may be substituted with from zero to five substituted groups R, when y is zero, and from one to four substituted groups R, when y is one; and each substituted group R comprises, independently, a radical selected from one of hydrocarbyl, silyl-hydrocarbyl or germyl-hydrocarbyl having from 1 to 30 carbon, silicon or germanium atoms, substituted hydrocarbyl, silyl-hydrocarbyl or germyl-hydrocarbyl radicals wherein one or more hydrogen atoms may be replaced by one or more of a halogen radical, an amido radical, a phosphido radical, an alkoxy radical, an aryloxy radical or any radical containing a Lewis acidic or basic functionality; C₁ to C₃₀ hydrocarbyl-substituted metalloid radicals wherein the metalloid is selected from one of Group 14 of the Periodic Table of Elements; halogen radicals; amido radicals; phosphido radicals; alkoxy radicals; or alkylborido radicals; or, Cp is a cyclopentadienyl ring in which at least two adjacent R-groups may be joined together and along with the carbon atoms to which they may be attached, form a C₄ to C₂₀ ring system which may be saturated, partially unsaturated or aromatic, and/or substituted or unsubstituted, the substitutions being selected as one or more R group as defined above;

J comprises a Group 15 or 16 heteroatom which may be substituted with one R′ group when J is a group 15 element, and y is one, or a group 16 element and y is zero, or with two R′ groups when J is a group 15 element and y is zero, or is unsubstituted when J is a Group 16 element and y is one; and each substituent group R′ is, independently, a radical selected from: hydrocarbyl, silyl-hydrocarbyl or germyl-hydrocarbyl radicals having 1 to 30 carbon, silicon or germanium atoms; substituted hydrocarbyl, silyl-hydrocarbyl or germyl-hydrocarbyl radicals wherein one or more hydrogen atoms is replaced by one or more of halogen radicals, amido radicals, phosphido radicals, alkoxy radicals, aryloxy radicals; or alkylborido radicals, preferably all R's are bonded to J through a 1°, 2°, or aromatic carbon atom, and are not directly bonded to a silicon or germanium atom;

each X comprises independently a monoanionic ligand selected from one of hydride; substituted or unsubstituted C₁ to C₃₀ hydrocarbyl; alkoxide; aryloxide; amide; halide or phosphide; Group 14 organometalloids; or both X's together may form an alkylidene or a cyclometallated hydrocarbyl or other dianionic ligand;

y is 0 or 1; and when y=1, A′ is a bridging group covalently bonded to both Cp and J, typically comprising at least one Group 13, 14 or 15 element such as carbon, silicon, boron, germanium, nitrogen or phosphorous with additional substituents R as defined above, so as to complete the valency of the Group 13, 14 or 15 element(s);

L is a neutral Lewis base other than water, such as an olefin, diolefin, aryne, amine, phosphine, ether or sulfide, e.g., diethylether, tetrahydrofuran, dimethylaniline, aniline, trimethylphosphine, n-butylamine; and w is a number from 0 to 3; and wherein the precatalyst is activated with an activator.

In a preferred embodiment M is Ti; X is chlorine, bromine, benzyl, phenyl, or a C₁ to C₁₂ alkyl group (such as methyl, ethyl, propyl, butyl, hexyl and octyl); y is 1; A′ is a bridging group comprising carbon or silica, such as dialkylsilyl preferably A′ is selected from CH₂, CH₂CH₂, CH(CH₃)₂, SiMe₂, SiPh₂, SiMePh, Si(CH₂)₃, (Ph)₂CH, (p-(Et)₃Si.Ph)₂CH and Si(CH₂)₄, where Ph is phenyl, Me is methyl, Et is ethyl; J is N—R′, where R′ is a C₁ to C₃₀ hydrocarbyl group, such as cyclododecyl, cyclohexyl, butyl (including t-butyl and sec-butyl), benzyl (including substituted benzyl), methyl, ethyl, pentyl, hexyl, neopentyl, cyclopentyl, decyl, propyl (including isopropyl, sec-propyl), norbornyl, and phenyl (including substituted phenyl, such as 3-t-butylphenyl, 2-methylphenyl); and Cp is cyclopentadienyl, substituted cyclopentadienyl, indenyl, substituted indenyl, fluorenyl, or substituted fluorenyl, where substituted means that at least one (alternately at least 2, 3, 4, 5, 6, 7, 8, or 9) hydrogen group on the group in question (e.g., cyclopentadiene, indene, fluorene, phenyl, benzyl, etc.) is replaced with a C₁ to C₃₀ hydrocarbyl, a heteroatom or heteroatom containing group (preferably methyl, ethyl, propyl, butyl, pentyl, hexyl, octyl, nonyl, decyl, phenyl, substituted phenyl, substituted benzyl, benzyl, cyclohexyl, and all isomers thereof). Two adjacent substitutions may form mononuclear or polynuclear rings, provided that substituted cyclopentadiene does not form an indene or fluorene and substituted indene does not form a fluorene.

In a preferred embodiment of any of the above, A′ is selected from R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R′₂SiSiR′₂, R₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′₂C—O—CR′₂, R′₂CR′₂C—O—CR′₂CR′₂, R′₂C—O—CR′₂CR′₂, R′₂C—O—CR′═CR′, R′₂C—S—CR′₂, R′₂CR′₂C—S—CR′₂CR′₂, R′₂C—S—CR′₂CR′₂, R′₂C—S—CR′—CR′, R′₂C—Se—CR′₂, R′₂CR′₂C—Se—CR′₂CR′₂, R′₂C—Se—CR₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR₁₂CR′₂, R′₂C—P═CR′, and R′₂C—PR′—CR′₂ where R′ is hydrogen or a C₁-C₂₀ containing hydrocarbyl, substituted hydrocarbyl, halocarbyl, substituted halocarbyl, silylcarbyl or germylcarbyl substituent and optionally two or more adjacent R′ may join to form a substituted or unsubstituted, saturated, partially unsaturated or aromatic, cyclic or polycyclic substituent.

Particularly useful catalyst compounds include: dimethylsilyl (tetramethylcyclopentadienyl) (R′-amido) titanium dimethyl or dichloride, where R′ is as defined above, especially dimethylsilyl (tetramethylcyclopentadienyl) (cyclododecylamido) titanium dimethyl or dichloride.

A list of precatalysts, useful herein, is located in U.S. Pat. No. 7,037,989, at Column 15, line 18 to Column 54, line 4.

### Activators and Activation Methods for Catalyst Compounds

The polymerization pre-catalyst compounds, described above, are typically activated in various ways to yield compounds having a vacant coordination site that will coordinate, insert, and polymerize olefin(s). For the purposes of this patent specification and appended claims, the terms “cocatalyst” and “activator” are used herein interchangeably and are defined to be any compound which can activate any one of the catalyst compounds described above by converting the neutral catalyst compound to a catalytically active catalyst compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract one reactive, σ-bound, metal ligand making the metal complex cationic and providing a charge-balancing noncoordinating or weakly coordinating anion.

### Aluminoxane and Aluminum Alkyl Activators

In one embodiment, alumoxane activators are utilized as an activator in the catalyst composition useful in the invention. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, particularly when the abstractable ligand is a halide, alkoxide or amide. Mixtures of different alumoxanes and modified alumoxanes may also be used.

The activator compounds comprising Lewis-acid activators and, in particular, alumoxanes, are represented by the following general formulae:

(R³—Al—O)ₚ (11)

R⁴(R⁵—Al—O)ₚ—AlR⁶₂ (12)

(M′)^{m+}Q′ₘ (13)

An alumoxane is generally a mixture of both the linear and cyclic compounds. In the general alumoxane formula, R³, R⁴, R⁵, and R⁶ are, independently a C₁-C₃₀ alkyl radical, for example, methyl, ethyl, propyl, butyl, pentyl, hexyl, heptyl, octyl, nonyl, decyl, and “p” is an integer from 1 to about 50. Most preferably, R³, R⁴, R⁵, and R⁶ are each methyl and “p” is at least 4. When an alkyl aluminum halide or alkoxide is employed in the preparation of the alumoxane, one or more R³⁻⁶ groups may be halide or alkoxide. M′ is a metal or metalloid, and Q′ is a partially or fully fluorinated hydrocarbyl.

It is recognized that alumoxane is not a discrete material. A typical alumoxane will contain free trisubstituted or trialkyl aluminum, bound trisubstituted or trialkyl aluminum, and alumoxane molecules of varying degree of oligomerization. Those methylalumoxanes most preferred contain lower levels of trimethylaluminum. Lower levels of trimethylaluminum can be achieved by reaction of the trimethylaluminum with a Lewis base or by vacuum distillation of the trimethylaluminum or by any other means known in the art. It is also recognized that after reaction with the transition metal compound, some alumoxane molecules are in the anionic form as represented by the anion in equations 4-6, thus for our purposes are considered “non-coordinating” anions.

For further descriptions, see U.S. Pat. Nos. 4,665,208; 4,952,540; 5,041,584; 5,091,352; 5,206,199; 5,204,419; 4,874,734; 4,924,018; 4,908,463; 4,968,827; 5,329,032; 5,248,801; 5,235,081; 5,157,137; 5,103,031; European Publications EP 0 561 476 A 1; EP 0 279 586 B1; EP 0 516 476 A; EP 0 594 218 A1; and PCT Publication WO 94/10180.

When the activator is an alumoxane (modified or unmodified), some embodiments select the maximum amount of activator at a 5000-fold molar excess Al/M over the catalyst precursor (per metal catalytic site). The minimum activator-to-catalyst-precursor is a 1:1 molar ratio.

Alumoxanes may be produced by the hydrolysis of the respective trialkylaluminum compound. MMAO may be produced by the hydrolysis of trimethylaluminum and a higher trialkylaluminum such as triisobutylaluminum. MMAO's are generally more soluble in aliphatic solvents and more stable during storage. There are a variety of methods for preparing alumoxane and modified alumoxanes, non-limiting examples of which are described in U.S. Pat. Nos. 4,665,208; 4,952,540; 5,091,352; 5,206,199; 5,204,419; 4,874,734; 4,924,018; 4,908,463; 4,968,827; 5,308,815; 5,329,032; 5,248,801; 5,235,081; 5,157,137; 5,103,031; 5,391,793; 5,391,529; 5,693,838; 5,731,253; 5,731,451; 5,744,656; 5,847,177; 5,854,166; 5,856,256; 5,939,346; European Publications EP-A-0 561 476; EP-B1-0 279 586; EP-A-0 594-218; EP-B1-0 586 665; PCT Publications WO 94/10180; and WO 99/15534; all of which are herein fully incorporated by reference. It may be preferable to use a visually clear methylalumoxane. A cloudy or gelled alumoxane can be filtered to produce a clear solution or clear alumoxane can be decanted from the cloudy solution. Another alumoxane is a modified methyl alumoxane (MMAO) cocatalyst type 3A (commercially available from Akzo Chemicals, Inc. under the trade name Modified Methylalumoxane type 3A, covered under U.S. Pat. No. 5,041,584).

Aluminum alkyl or organoaluminum compounds which may be utilized as activators (or scavengers) include trimethylaluminum, triethylaluminum, triisobutylaluminum, tri-n-hexylaluminum, tri-n-octylaluminum, diethylzinc and the like.

### Ionizing Activators

It is within the scope of this invention to use an ionizing or stoichiometric activator, neutral or ionic, such as tri (n-butyl) ammonium tetrakis (pentafluorophenyl) boron, a trisperfluorophenyl boron metalloid precursor or a trisperfluoronaphtyl boron metalloid precursor, polyhalogenated heteroborane anions (WO 98/43983), boric acid (U.S. Pat. No. 5,942,459) or combination thereof. It is also within the scope of this invention to use neutral or ionic activators alone or in combination with alumoxane or modified alumoxane activators.

Examples of neutral stoichiometric activators include tri-substituted boron, tellurium, aluminum, gallium and indium or mixtures thereof. The three substituent groups are each independently selected from alkyls, alkenyls, halogen, substituted alkyls, aryls, arylhalides, alkoxy and halides. Preferably, the three groups are independently selected from halogen, mono or multicyclic (including halosubstituted) aryls, alkyls, and alkenyl compounds and mixtures thereof, preferred are alkenyl groups having 1 to 20 carbon atoms, alkyl groups having 1 to 20 carbon atoms, alkoxy groups having 1 to 20 carbon atoms and aryl groups having 3 to 20 carbon atoms (including substituted aryls). More preferably, the three groups are alkyls having 1 to 4 carbon groups, phenyl, napthyl or mixtures thereof. Even more preferably, the three groups are halogenated, preferably fluorinated, aryl groups.

Most preferably, the neutral stoichiometric activator is trisperfluorophenyl boron or trisperfluoronapthyl boron.

Ionic stoichiometric activator compounds may contain an active proton, or some other cation associated with, but not coordinated to, or only loosely coordinated to, the remaining ion of the ionizing compound. Such compounds and the like are described in European Publications EP-A-0 570 982; EP-A-0 520 732; EP-A-0 495 375; EP-B1-0 500 944; EP-A-0 277 003; EP-A-0 277 004; U.S. Pat. Nos. 5,153,157; 5,198,401; 5,066,741; 5,206,197; 5,241,025; 5,384,299; 5,502,124; and U.S. patent application Ser. No. 08/285,380, filed Aug. 3, 1994; all of which are herein fully incorporated by reference.

Ionic catalysts can be preparedly reacting a transition metal compound with some neutral Lewis acids, such as B(C₆F₆)₃, which upon reaction with the hydrolyzable ligand (X) of the transition metal compound forms an anion, such as ([B(C₆F₅)₃(X)]⁻), which stabilizes the cationic transition metal species generated by the reaction. The catalysts may be, and preferably are, prepared with activator components which are ionic compounds or compositions. However, preparation of activators utilizing neutral compounds is also contemplated by this invention.

Compounds useful as an activator component in the preparation of the ionic catalyst systems used in the process of this invention comprise a cation, which is preferably a Bronsted acid capable of donating a proton, and a compatible non-coordinating anion which anion is relatively large (bulky), capable of stabilizing the active catalyst species (the Group 4 cation), which is formed when the two compounds are combined and said anion will be sufficiently labile to be displaced by olefinic diolefinic and acetylenically unsaturated substrates or other neutral Lewis bases such as ethers, nitriles and the like. Two classes of compatible non-coordinating anions have been disclosed in EP-A-0 277 003 and EP-A-0 277 004 published 1988: 1) anionic coordination complexes comprising a plurality of lipophilic radicals covalently coordinated to and shielding a central charge-bearing metal or metalloid core; and 2) anions comprising a plurality of boron atoms such as carboranes, metallacarboranes and boranes.

In a preferred embodiment, the stoichiometric activators include a cation and an anion component, and may be represented by the following formula:

(L-H)_{d}⁺(A^{d-}) (14)

wherein L is an neutral Lewis base;
H is hydrogen;
(L-H)⁺ is a Bronsted acid;
A^{d-} is a non-coordinating anion having the charge d−;
d is an integer from 1 to 3.

The cation component, (L-H)_{d}⁺ may include Bronsted acids such as protons or protonated Lewis bases or reducible Lewis acids capable of protonating or abstracting a moiety, such as an alkyl or aryl, from the bulky ligand metallocene containing transition metal catalyst precursor, resulting in a cationic transition metal species.

The activating cation (L-H)_{d}⁺ may be a Bronsted acid, capable of donating a proton to the transition metal catalytic precursor resulting in a transition metal cation, including ammoniums, oxoniums, phosphoniums, silyliums, and mixtures thereof, preferably ammoniums of methylamine, aniline, dimethylamine, diethylamine, N-methylaniline, diphenylamine, trimethylamine, triethylamine, N,N-dimethylaniline, methyldiphenylamine, pyridine, p-bromo N,N-dimethylaniline, p-nitro-N,N-dimethylaniline, phosphoniums from triethylphosphine, triphenylphosphine, and diphenylphosphine, oxomiuns from ethers such as dimethyl ether diethyl ether, tetrahydrofuran and dioxane, sulfoniums from thioethers, such as diethyl thioethers and tetrahydrothiophene, and mixtures thereof. The activating cation (L-H)_{d}⁺ may also be a moiety such as silver, tropylium, carbeniums, ferroceniums and mixtures, preferably carboniums and ferroceniums. Most preferably, (L-H)_{d}⁺ is triphenyl carbonium.

The anion component A^{d-} include those having the formula [M^{k+}Qₙ]^{d-} wherein k is an integer from 1 to 3; n is an integer from 2 to 6; n−k=d; M is an element selected from Group 13 of the Periodic Table of the Elements, preferably, boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group having 1 to 20 carbon atoms, more preferably, each Q is a fluorinated aryl group, and most preferably, each Q is a pentafluoryl aryl group. Examples of suitable A^{d-} also include diboron compounds as disclosed in U.S. Pat. No. 5,447,895, which is fully incorporated herein by reference.

Illustrative, but not limiting, examples of boron compounds which may be used as an activating cocatalyst in the preparation of the improved catalysts of this invention are tri-substituted ammonium salts such as: trimethylammonium tetraphenylborate, triethylammonium tetraphenylborate, tripropylammonium tetraphenylborate, tri(n-butyl)ammonium tetraphenylborate, tri(t-butyl)ammonium tetraphenylborate, N,N-dimethylanilinium tetraphenylborate, N,N-diethylanilinium tetraphenylborate, N,N-dimethyl-(2,4,6-trimethylanilinium) tetraphenylborate, tropillium tetraphenylborate, triphenylcarbenium tetraphenylborate, triphenylphosphonium tetraphenylborate triethylsilylium tetraphenylborate, benzene(diazonium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium) tetrakis(pentafluorophenyl)borate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium) tetrakis(pentafluorophenyl)borate, trimethylammonium tetrakis-(2,3,4,6-tetrafluorophenyl) borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluoro-phenyl)borate, dimethyl(t-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium)tetrakis-(2,3,4,6-tetrafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium) tetrakis-(2,3,4,6-tetrafluorophenyl)borate, trimethylammonium tetrakis(perfluoronapthyl)borate, triethylammonium tetrakis(perfluoronapthyl)borate, tripropylammonium tetrakis(perfluoronapthyl)borate, tri(n-butyl)ammonium tetrakis(perfluoronapthyl)borate, tri(t-butyl)ammonium tetrakis(perfluoronapthyl)borate, N,N-dimethylanilinium tetrakis(perfluoronapthyl)borate, N,N-diethylanilinium tetrakis(perfluoronapthyl)borate, N,N-dimethyl-(2,4,6-trimethylanilinium) tetrakis(perfluoronapthyl)borate, tropillium tetrakis(perfluoronapthyl)borate, triphenylcarbenium tetrakis(perfluoronapthyl)borate, triphenylphosphonium tetrakis(perfluoronapthyl)borate, triethylsilylium tetrakis(perfluoronapthyl)borate, benzene(diazonium) tetrakis(perfluoronapthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(t-butyl)ammonium tetrakis(perfluorobiphenyl)borate, N,N-dimethylanilinium tetrakis(perfluorobiphenyl)borate, N,N-diethylanilinium tetrakis(pedluorobiphenyl)borate, N,N-dimethyl-(2,4,6-trimethylanilinium) tetrakis(perfluorobiphenyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium) tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(t-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium) tetrakis(3,5-bis(trifluoromethyl)phenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, benzene(diazonium) tetrakis(3,5-bis(trifluoromethyl)phenyl)borate, and dialkyl ammonium salts such as: di-(i-propyl)ammonium tetrakis(pentafluorophenyl)borate, and dicyclohexylammonium tetrakis(pentafluorophenyl)borate; and additional tri-substituted phosphonium salts such as tri(o-tolyl)phosphonium tetrakis(pentafluorophenyl)borate, and tri(2,6-dimethylphenyl)phosphonium tetrakis(pentafluorophenyl)borate.

Most preferably, the ionic stoichiometric activator (L-H)_{d}⁺(^{Ad-}) is N,N-dimethylanilinium tetra(perfluorophenyl)borate, N,N-dimethylanilinium tetrakis(perfluoronapthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronapthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

In one embodiment, an activation method using ionizing ionic compounds not containing an active proton but capable of producing a bulky ligand metallocene catalyst cation and their non-coordinating anion are also contemplated, and are described in EP-A-0 426 637; EP-A-0 573 403; and U.S. Pat. No. 5,387,568, which are all herein incorporated by reference.

The term “non-coordinating anion” (NCA) means an anion which either does not coordinate to said cation or which is only weakly coordinated to said cation thereby remaining sufficiently labile to be displaced by a neutral Lewis base. “Compatible” NCAs are those which are not degraded to neutrality when the initially formed complex decomposes. Further, the anion will not transfer an anionic substituent or fragment to the cation so as to cause it to form a neutral four coordinate metallocene compound and a neutral by-product from the anion. NCAs useful in accordance with this invention are those that are compatible, stabilize the metallocene cation in the sense of balancing its ionic charge at +1, yet retain sufficient lability to permit displacement by an ethylenically or acetylenically unsaturated monomer during polymerization. These types of cocatalysts sometimes use tri-isobutyl aluminum or tri-octyl aluminum as a scavenger.

Invention process also can employ cocatalyst compounds or activator compounds that are initially neutral Lewis acids but form a cationic metal complex and a NCA, or a zwitterionic complex upon reaction with the invention compounds. For example, tris(pentafluorophenyl) boron or aluminum act to abstract a hydrocarbyl or hydride ligand to yield an invention cationic metal complex and stabilizing NCA, see EP-A-0 427 697 and EP-A-0 520 732 for illustrations of analogous Group-4 metallocene compounds. Also, see the methods and compounds of EP-A-0 495 375. For formation of zwitterionic complexes using analogous Group 4 compounds, see U.S. Pat. Nos. 5,624,878; 5,486,632; and 5,527,929.

When the cations of noncoordinating anion precursors are Bronsted acids such as protons or protonated Lewis bases (excluding water), or reducible Lewis acids such as ferrocenium or silver cations, or alkali or alkaline earth metal cations such as those of sodium, magnesium or lithium, the catalyst-precursor-to-activator molar ratio may be any ratio. Combinations of the described activator compounds may also be used for activation. For example, tris(perfluorophenyl) boron can be used with methylalumoxane.

### Conventional-Type Cocatalysts (Activators)

Typically, conventional transition metal catalyst compounds, excluding some conventional-type chromium catalyst compounds, are activated with one or more of the conventional cocatalysts which may be represented by the formula:

M³M⁴ᵥX²_{c}R²_{b-c} (15)

wherein M³ is a metal from Group 1 to 3 and 12 to 13 of the Periodic Table of Elements; M⁴ is a metal of Group 1 of the Periodic Table of Elements; v is a number from 0 to 1; each X² is any halogen; c is a number from 0 to 3; each R² is a monovalent hydrocarbon radical or hydrogen; b is a number from 1 to 4; and wherein b minus c is at least 1. Other conventional-type organometallic cocatalyst compounds for the above conventional-type transition metal catalysts have the formula M³R²ₖ, where M³ is a Group IA, IIA, IIB or IIIA metal, such as lithium, sodium, beryllium, barium, boron, aluminum, zinc, cadmium, and gallium; k equals 1, 2 or 3 depending upon the valency of M³ which valency in turn normally depends upon the particular Group to which M³ belongs; and each R² may be any monovalent hydrocarbon radical.

Non-limiting examples of conventional-type organometallic cocatalyst compounds useful with the conventional-type catalyst compounds, described above, include methyllithium, butyllithium, dihexylmercury, butylmagnesium, diethylcadmium, benzylpotassium, diethylzinc, tri-n-butylaluminum, diisobutyl ethylboron, diethylcadmium, di-n-butylzinc and tri-n-amylboron, and, in particular, the aluminum alkyls, such as tri-hexyl-aluminum, triethylaluminum, trimethylaluminum, and tri-isobutylaluminum. Other conventional-type cocatalyst compounds include mono-organohalides and hydrides of Group 2 metals, and mono- or di-organohalides and hydrides of Group 3 and 13 metals. Non-limiting examples of such conventional-type cocatalyst compounds include di-isobutylaluminum bromide, isobutylboron dichloride, methyl magnesium chloride, ethylberyllium chloride, ethylcalcium bromide, di-isobutylaluminum hydride, methylcadmium hydride, diethylboron hydride, hexylberyllium hydride, dipropylboron hydride, octylmagnesium hydride, butylzinc hydride, dichloroboron hydride, di-bromo-aluminum hydride and bromocadmium hydride. Conventional-type organometallic cocatalyst compounds are known to those in the art and a more complete discussion of these compounds may be found in U.S. Pat. Nos. 3,221,002 and 5,093,415; which are herein fully incorporated by reference.

### Additional Activators

Other activators include those described in PCT publication WO 98/07515, such as tris (2,2′,2″-nonafluorobiphenyl) fluoroaluminate, which publication is fully incorporated herein by reference. Combinations of activators are also contemplated by the invention, for example, alumoxanes and ionizing activators in combinations, see for example, EP-B1 0 573 120; PCT Publications WO 94/07928; WO 95/14044; U.S. Pat. Nos. 5,153,157; and 5,453,410; all of which are herein fully incorporated by reference.

Other suitable activators are disclosed in WO 98/09996, incorporated herein by reference, which describes activating bulky ligand metallocene catalyst compounds with perchlorates, periodates and iodates including their hydrates. WO 98/30602 and WO 98/30603, incorporated by reference, describe the use of lithium (2,2′-bisphenyl-ditrimethylsilicate)•4THF as an activator for a bulky ligand metallocene catalyst compound. WO 99/18135, incorporated herein by reference, describes the use of organo-boron-aluminum activators. EP-B 1-0 781 299, incorporated herein by reference, describes using a silylium salt in combination with a non-coordinating compatible anion. Also, methods of activation such as using radiation (see EP-B1-0.615 981, incorporated herein by reference), electro-chemical oxidation, and the like are also contemplated as activating methods for the purposes of rendering the neutral bulky ligand metallocene catalyst compound or precursor to a bulky ligand metallocene cation capable of polymerizing olefins. Other activators or methods for activating a bulky ligand metallocene catalyst compound are described in, for example, U.S. Pat. Nos. 5,849,852; 5,859,653; 5,869,723; WO 98/32775; and WO 99/42467 (dioctadecylmethylammonium-bis(tris(pentafluorophenyl)borane)benzimidazolide), which are herein incorporated by reference.

Another suitable ion forming, activating cocatalyst comprises a salt of a cationic oxidizing agent and a noncoordinating, compatible anion represented by the formula:

(OX^{e+})_{d}(A^{d-})ₑ (16)

wherein OX^{e+} is a cationic oxidizing agent having a charge of e+; e is an integer from 1 to 3; and A⁻, and d are as previously defined. Examples of cationic oxidizing agents include: ferrocenium, hydrocarbyl-substituted ferrocenium, Ag⁺, or Pb+². Preferred embodiments of A^{d-} are those anions previously defined with respect to the Bronsted acid containing activators, especially tetrakis(pentafluorophenyl)borate.

### Activator Combinations

It is within the scope of this invention that catalyst compounds can be combined with one or more activators or activation methods described above. For example, a combination of activators have been described in U.S. Pat. Nos. 5,153,157; 5,453,410; European Publication EP-B10 573 120; PCT Publications WO 94/07928; and WO 95/14044, incorporated herein by reference. These documents all discuss the use of an alumoxane in combination with an ionizing activator.

### The Choice of Transition Metal Catalyst Components

When two transition metal compound based catalysts are used in one reactor as a mixed catalyst system, the two transition metal compounds should be chosen such that the two are compatible. A simple screening method such as by ¹H or ¹³C NMR, known to those of ordinary skill in the art, can be used to determine which transition metal compounds are compatible.

It is preferable to use the same activator for the transition metal compounds, however, two different activators, such as a non-coordinating anion activator and an alumoxane, can be used in combination. If one or more transition metal compounds contain an X₁ or X₂ ligand which is not a hydride, hydrocarbyl, or substituted hydrocarbyl, then the alumoxane should be contacted with the transition metal compounds prior to addition of the non-coordinating anion activator.

The two transition metal compounds (pre-catalysts) may be used in any ratio. Preferred molar ratios of (A) transition metal compound to produce first polymer to (B) transition metal compound to produce second polymer fall within the range of (A:B) 1:1000 to 1000:1, alternatively 1:100 to 500:1, alternatively 1:10 to 200:1, alternatively 1:1 to 100:1, alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, the preferred mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

In general, the combined pre-catalyst compounds and the activator are combined in ratios of about 1:10000 to about 10:1. When alumoxane or aluminum alkyl activators are used, the combined pre-catalyst-to-activator molar ratio is from 1:5000 to 10:1, alternatively from 1:1000 to 10:1, alternatively 1:500 to 2:1, or alternatively 1:300 to 1:1. When ionizing activators are used, the combined pre-catalyst-to-activator molar ratio is from 10:1 to 1:10, 5:1 to 1:5, 2:1 to 1:2, or 1.2:1 to 1:1. Multiple activators may be used, including using mixes of alumoxanes or aluminum alkyls with ionizing activators.

Three transition metal compounds (pre-catalysts) may be used in any ratio. Preferred molar ratios of (A) transition metal compound to produce low ethylene content polymer to (B) transition metal compound to produce high ethylene content polymer to (C) transition metal compound to produce wax fall within the range of (A:B:C) 1:1000:500 to 1000:1:1, alternatively 1:100:50 to 500:1:1, alternatively 1:10:10 to 200:1:1, alternatively 1:1:1 to 100:1:50, alternatively 1:1:10 to 75:1:50, and alternatively 5:1:1 to 50:1:50. The particular ratio chosen will depend on the exact pre-catalysts chosen, the method of activation, and the end product desired. A chain transfer agent (such as an aluminum alkyl or dialkyl zinc, such as diethyl zinc) may also be included with one, two, or three catalysts.

### Supports

In another embodiment the catalyst compositions of this invention include a support material or carrier. For example, the one or more catalyst components and/or one or more activators may be deposited on, contacted with, vaporized with, bonded to, or incorporated within, adsorbed or absorbed in, or on, one or more supports or carriers.

The support material is any of the conventional support materials. Preferably the supported material is a porous support material, for example, talc, inorganic oxides and inorganic chlorides. Other support materials include resinous support materials such as polystyrene, functionalized or crosslinked organic supports, such as polystyrene divinyl benzene polyolefins or polymeric compounds, zeolites, clays, or any other organic or inorganic support material and the like, or mixtures thereof.

The preferred support materials are inorganic oxides that include Group 2, 3, 4, 5, 13, or 14 metal oxides. The preferred supports include silica, which may or may not be dehydrated, fumed silica, alumina (WO 99/60033), silica-alumina and mixtures thereof. Other useful supports include magnesia, titania, zirconia, magnesium chloride (U.S. Pat. No. 5,965,477), montmorillonite (European Patent EP-B1 0 511 665), phyllosilicate, zeolites, talc, clays (U.S. Pat. No. 6,034,187) and the like. Also, combinations of these support materials may be used, for example, silica-chromium, silica-alumina, silica-titania and the like. Additional support materials may include those porous acrylic polymers described in EP 0 767 184 B1, which is incorporated herein by reference. Other support materials include nanocomposites as described in PCT WO 99/47598, aerogels as described in WO 99/48605, spherulites as described in U.S. Pat. No. 5,972,510 and polymeric beads as described in WO 99/50311, which are all herein incorporated by reference.

It is preferred that the support material, most preferably an inorganic oxide, has a surface area in the range of from about 10 to about 700 m²/g, pore volume in the range of from about 0.1 to about 4.0 cc/g and average particle size in the range of from about 5 to about 500 μm. More preferably, the surface area of the support material is in the range of from about 50 to about 500 m²/g, pore volume of from about 0.5 to about 3.5 cc/g and average particle size of from about 10 to about 200 μm. Most preferably, the surface area of the support material is in the range from about 100 to about 400 m²/g, pore volume from about 0.8 to about 3.0 cc/g and average particle size is from about 5 to about 100 μm. The average pore size of the carrier useful in the invention typically has pore size in the range of from 10 to 1000 Å, preferably 50 to 500 Å, and most preferably 75 to 350 Å.

As is well known in the art, the catalysts may also be supported together on one inert support, or the catalysts may be independently placed on two inert supports and subsequently mixed. Of the two methods, the former is preferred.

In another embodiment the support may comprise one or more types of support material which may be treated differently. For example one could use two different silicas that had different pore volumes or had been calcined at different temperatures. Likewise one could use a silica that had been treated with a scavenger or other additive and a silica that had not.

### Polymerization Process

In the process of polymerization the desired structure of the polymer which contains a substantial amount of both odd and even distribution of methylene residues is determined by a combination of one of the following synthetic strategies. The first strategy is to incorporate a vicinally disubstituted olefin into the polymer, the second is the insertion of an internal or cyclic olefin, and the third is the use of a catalyst system and a polymerization conditions, which promotes the 2,1 insertion of a component alpha olefin, particularly propylene. These strategies are useful in the context of using polymerization catalysts and process conditions that incorporate these comonomers during a continuous feed stirred tank polymerization. In general the invention uses a solution polymerization process using a homogeneous polymerization mixture, a high polymerization temperature (e.g., above 65° C., preferably above 100° C.) to yield a polymer containing between 40 wt % to 80 wt % of ethylene with the balance being other components, and a weight average molecular weight of greater than 40,000 g/mol. Usefully, the process of this invention can use lesser amounts of ethylene and comonomer, for example, in a preferred embodiment, ethylene is present in the feed materials (all monomers, comonomer solvents and diluents fed into the reactor) at less than 8 g/liter, alternately less than 5 g/liter, alternately less than 3 g/liter. Similarly lesser amounts of comonomer can also be used. For example, comonomers (such as propylene, butene, hexene, and/or octene) are preferably present in the feed materials at less than 25 g/liter, alternately at less than 15 g/liter, alternately at less than 8 g/liter.

The catalysts and catalyst systems described above are suitable for use in a solution, bulk, gas, or slurry polymerization process, or a combination thereof, preferably solution phase or bulk phase polymerization process.

In one embodiment, this invention is directed toward the solution, bulk, slurry, or gas phase polymerization reactions involving the polymerization of ethylene, an alpha olefin, and preferably one or more of the comonomers described above.

One or more reactors, in series or in parallel, may be used in the present invention. Catalyst component and activator may be delivered as a solution or slurry, either separately to the reactor, activated in-line just prior to the reactor, or preactivated and pumped as an activated solution or slurry to the reactor. A preferred operation is two solutions activated in-line. For more information on methods to introduce multiple catalysts into reactors, please see U.S. Pat. No. 6,399,722 and WO 01/30862A1. While these^{.} references may emphasize gas phase reactors, the techniques described are equally applicable to other types of reactors, including continuous stirred tank reactors, slurry loop reactors, and the like. Polymerizations are carried out in either single reactor operation, in which monomer, comonomers, catalyst/activator, scavenger, and optional modifiers are added continuously to a single reactor or in series reactor operation, in which the above components are added to each of two or more reactors connected in series. The catalyst components can be added to the first reactor in the series. The catalyst component may also be added to both reactors, with one component being added to first reaction and another component to other reactors.

In one embodiment 500 ppm or less of hydrogen is added to the polymerization, or 400 ppm or less, or 300 ppm or less. In other embodiments at least 50 ppm of hydrogen is added to the polymerization, or 100 ppm or more, or 150 ppm or more.

### Gas Phase Polymerization

Generally, in a fluidized gas bed process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference.)

### Slurry Phase Polymerization

A slurry polymerization process generally operates between about 1 to about 50 atmosphere pressure range (15 psi to 735 psi, 103 kPa to 5068 kPa) or even greater and temperatures in the range of about 0° C. to about 120° C. In a slurry polymerization, a suspension of solid, particulate polymer is formed in a liquid polymerization diluent medium to which monomer and comonomers along with catalyst are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used, the process must be operated above the reaction diluent critical temperature and pressure. Preferably, a hexane or an isobutane medium is employed.

In one embodiment, a preferred polymerization technique useful in the invention is referred to as a particle form polymerization or a slurry process where the temperature is kept below the temperature at which the polymer goes into solution. Such technique is well known in the art and described in, for instance, U.S. Pat. No. 3,248,179, which is fully incorporated herein by reference. The preferred temperature in the particle form process is within the range of about 85° C. to about 110° C. Two preferred polymerization methods for the slurry process are those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484, which is herein fully incorporated by reference.

In another embodiment, the slurry process is carried out continuously in a loop reactor. The catalyst, as a slurry in isobutane or as a dry free flowing powder, is injected regularly to the reactor loop, which is itself filled with circulating slurry of growing polymer particles in a diluent of isobutane containing monomer and comonomer. Hydrogen, optionally, may be added as a molecular weight control. (In one embodiment, 500 ppm or less of hydrogen is added, or 400 ppm or less, or 300 ppm or less. In other embodiments at least 50 ppm of hydrogen is added, or 100 ppm or more, or 150 ppm or more.)

The reactor is maintained at a pressure of 3620 kPa to 4309 kPa and at a temperature in the range of about 60° C. to about 104° C., depending on the desired polymer melting characteristics. Reaction heat is removed through the loop wall since much of the reactor is in the form of a double-jacketed pipe. The slurry is allowed to exit the reactor at regular intervals or continuously to a heated low pressure flash vessel, rotary dryer and a nitrogen purge column in sequence for removal of the isobutane diluent and all unreacted monomer and comonomers. The resulting hydrocarbon free powder is then compounded for use in various applications.

In another embodiment, the process described herein (particularly the slurry process) is capable of producing greater than 2,000 lbs of polymer per hour (907 Kg/hr), preferably greater than 5,000 lbs/hr (2,268 Kg/hr), preferably greater than 10,000 lbs/hr (4,540 Kg/hr), preferably greater than 15,000 lbs of polymer per hour (6,804 Kg/hr), preferably greater than 25,000 lbs/hr (11,340 Kg/hr) to about 100,000 lbs/hr (45,500 Kg/hr).

In another embodiment, the slurry process, useful in the invention, has a total reactor pressure in the range of from 400 psig (2758 kPa) to 800 psig (5516 kPa), preferably 450 psig (3103 kPa) to about 700 psig (4827 kPa), more preferably 500 psig (3448 kPa) to about 650 psig (4482 kPa), most preferably from about 525 psig (3620 kPa) to 625 psig (4309 kPa).

In yet another embodiment, the slurry process, useful in the invention, has a concentration of predominant monomer in the reactor liquid medium in the range of from about 1 wt % to about 10 wt %, preferably from about 2 wt % to about 7 wt %, more preferably from about 2.5 wt % to about 6 wt %, most preferably from about 3 wt % to about 6 wt %.

Another process, useful in the invention, is where the process, preferably a slurry process, is operated in the absence of or essentially free of any scavengers, such as triethylaluminum, trimethylaluminum, tri-isobutylaluminum, tri-n-hexylaluminum, diethyl aluminum chloride, diethyl zinc, dibutyl zinc, and the like. This process is described in PCT publication WO 96/08520 and U.S. Pat. No. 5,712,352, which are herein fully incorporated by reference.

In another embodiment the process is run with scavengers. Typical scavengers include trimethyl aluminum, tri-isobutyl aluminum, and an excess of alumoxane or modified alumoxane.

### Homogeneous, Bulk, or Solution Phase Polymerization

The catalysts described herein can be used advantageously in homogeneous solution processes. Generally this involves polymerization in a continuous reactor in which the polymer formed and the starting monomer and catalyst materials supplied, are agitated to reduce or avoid concentration gradients. Suitable processes operate above the melting point of the polymers at high pressures, from 1 to 3000 bar (10-30,000 MPa), in which the monomer acts as diluent or in solution polymerization using a solvent.

Temperature control in the reactor is obtained by balancing the heat of polymerization with reactor cooling by reactor jackets or cooling coils to cool the contents of the reactor, auto refrigeration, pre-chilled feeds, vaporization of liquid medium (diluent, monomers, or solvent), or combinations of all three. Adiabatic reactors with pre-chilled feeds may also be used. The reactor temperature depends on the catalyst used. In general, the reactor temperature preferably may vary between about 30° C. and about 160° C., more preferably from about 90° C. to about 150° C., most preferably from about 100° C. to about 140° C. Polymerization temperature may vary depending on catalyst choice. For example, a diimine Ni catalyst may be used at 40° C., while a metallocene Ti catalyst can be used at 100° C. or more. In series operation, the second reactor temperature is preferably higher than the first reactor temperature. In parallel reactor operation, the temperatures of the two reactors are independent. The pressure can vary from about 1 mm Hg to about 2500 bar (25,000 MPa), preferably from about 0.1 bar to about 1600 bar (1-16,000 MPa), most preferably from about 1.0 to about 500 bar (10-5000 MPa).

In one embodiment, 500 ppm or less of hydrogen is added to the polymerization, or 400 ppm or less, or 300 ppm or less. In other embodiments, at least 50 ppm of hydrogen is added to the polymerization, or 100 ppm or more, or 150 ppm or more.

Each of these processes may also be employed in single reactor, parallel, or series reactor configurations. The liquid processes comprise contacting olefin monomers with the above described catalyst system in a suitable diluent or solvent and allowing said monomers to react for a sufficient time to produce the desired polymers. Hydrocarbon solvents are suitable, both aliphatic and aromatic. Alkanes, such as hexane, pentane, isopentane, and octane, are preferred.

The process can be carried out in a continuous stirred tank reactor, batch reactor or plug flow reactor, or more than one reactor operated in series or parallel. These reactors may or may not have internal cooling or heating and the monomer feed may or may not be refrigerated. See the general disclosure of U.S. Pat. No. 5,001,205 for general process conditions. See also, international applications WO 96/33227 and WO 97/22639. All documents are incorporated by reference for US purposes for description of polymerization processes, metallocene selection, and useful scavenging compounds.

### Ethylene Alpha-Olefin Copolymers

In a preferred embodiment, the ethylene alpha-olefin copolymers prepared herein comprise: ethylene; at least one alpha-olefin having 3 or more carbon atoms; and at least one vicinally substituted olefin having 2 to 40 carbon atoms; wherein: the ethylene alpha-olefin copolymer has a weight-average molecular weight (Mw) of about 50,000 to about 500,000 g/mol and an intensity ratio of S_{αβ} to S_{αα}, as determined by a ¹³C-NMR spectrum, of less than or equal to 0.5.

In another embodiment, the ethylene alpha-olefin copolymers prepared herein comprise: at least 40 mole % ethylene; at least 5 mole % propylene; at least 5 mole % of vicinally disubstituted monomer, wherein the copolymer has: an Mw of 500 to 120,000 g/mol, from 3 to 28 total stereo defects per 10,000 carbon atoms, and an intensity ratio of S_{αβ} to S_{αα}, as determined by a ¹³C-NMR spectrum of 0.5 or more.

¹³C-NMR spectroscopy is used to determine the “total stereo defects per 10,000 carbon atoms.” The samples for ¹³C-NMR spectroscopy are dissolved in d₂-1,1,2,2-tetrachloroethane and the samples are recorded at 125° C. using a NMR spectrometer with a ¹³C-NMR frequency of 100 or 175 MHz. Resonance peaks are referenced to mmmm=21.8 ppm. Calculations involved in the characterization of the copolymers by NMR follow the work of F. A. Bovey in “Polymer Conformation and Configuration” Academic Press, New York 1969 and J. Randall in “Polymer Sequence Determination, Carbon-13 NMR Method”, Academic Press, New York, 1977.

The stereo defects measured as “total stereo defects/10,000 carbon atoms” are calculated from the sum of the intensities of mmrr, mmrm+rrmr, and rmrm resonance peaks times 5000. The intensities used in the calculations are normalized to the total number of monomers in the sample. The intensity from mmrr are corrected for 2,1-insertions; the intensity from mmrm+rrmr are corrected for 1,3-insertions; n-propyl and n-butyl endgroups; and the intensity from rmrm are corrected for 2,3-dimethylbutyl endgroup at 20.55 ppm.

The “total defects/10,000 monomer units” is the sum of the “stereo defects/10,000 monomer units,” the “2,1-regio (erythro) defects/10,000 monomer units,” the “2,1-regio (threo) defects/10,000 monomer units” and the “1,3-regio defects/10,000 monomer units.”

Each S_{αβ} and S_{αα}, as measured by ¹³C-NMR spectrum, is a peak intensity of CH₂ in the units derived from ethylene or an alpha-olefin of 3 or more carbon atoms and they mean two kinds of CH₂ different in the position to the tertiary carbon as shown below;

—CHR—CH₂—CH₂—CHR— S_{αβ}

—CH₂—CHR—CH₂—CHR— S_{αα}

The ¹³C-NMR spectrum thus measured was analyzed and then S_{αβ} and S_{αα} are determined in accordance with the method reported by J. C. Randall (Macromolecules, 11, 33 (1978)).

The intensity ratio, S_{αβ}/S_{αα}, is calculated from a ratio of an integral value (area) of each peak. It is generally considered that the thus obtained value of the intensity ratio is a measure indicating a ratio of such reactions as an occurrence of 1-2 addition reaction of α-olefin followed by 2-1 addition reaction or an occurrence of 2-1 addition reaction of α-olefin followed by 1-2 addition reaction. Consequently, it is indicated that the larger the intensity, ratio is, more irregular the bonding direction of α-olefin is. On the other hand, the smaller the intensity ratio is, more regular the bonding direction of α-olefin is. When the ratio satisfies the above formula (S_{αβ}/S_{αα}≦0.5), the fluidity of a lubricating oil at low temperature is improved and the lubricating properties at high temperature can also be improved. Further, the lubricating oil shows excellent balance of the lubricating properties at low temperature and high temperature.

In defining the concept of the odd and the even distribution of methylene sequences, it is useful to note that insertion of ethylene into a copolymer leads to the generation of two methylene sequences and the insertion of C₃ or greater alpha olefins into a copolymer leads to the generation of one methylene sequences. The incorporation of internal olefins or cyclic olefins lead to none. Every methylene insertion is contained in a sequence of the contiguous methylene units; for single methylene units this sequence length is one. In ethylene-alpha olefin copolymers, where all of the alpha-olefin is inserted in a 1,2 stereochemistry, almost all of the methylene sequences contain an odd number of methylene units; that is, the number of methylene units in a contiguous run is either one, three, five, seven or other odd number. The insertion of a internal or cyclic olefin requires the formation of a set of even and odd methylene sequences. In even methylene sequences the contiguous units contain two, four, six, eight or other even number of units.

The absolute amounts of the odd and even methylene sequences are difficult to predetermine discretely. In general, the polymerization catalysts and process can be designed to determine the relative number of odd and even methylene sequences; however, the distribution of contiguous methylene units in each of the odd or even classes is determined by the average composition of the copolymer. Thus, changes in the composition of the copolymer change, to some extent, the number of methylene sequences which have odd and even methylene components but, profoundly change the number average of the methylene sequences to larger numbers. Thus, on increasing the ethylene content from, for example, 45 wt % to 80 wt % ethylene, the number average of methylene sequences in both the odd and even sequences will rise from, say, 5 to 10 while the change in the relative number of the odd and even contiguous catenates will be less affected. The determination of the ratio is by the determination of the S_{αβ}/S_{αα} by ¹³C-NMR ratio which should be 0.5 or more, preferably greater than 0.5. In a preferred embodiment, the ratio of even to odd methylene sequences would be 0.1:1 to 10:1, preferably greater than 0.3:1 preferably greater than 1:1 as determined by ¹³C-NMR.

As noted above, metallocene polymerizations have a much lower tendency to incorporate propylene in a 2,1 manner compared to traditional Ziegler Natta catalysts. Without wishing to be bound by theory, it is believed, by the inventors, that the presence of such as the predominant mode of insertion of propylene would lead to, in ethylene propylene polymers, a measureable lack of diversity or distribution of the number of methylene carbon atoms in contiguous sequences in that the majority of them would be numerically odd. It is further believed, by the inventors, that such a predominant microstructure of the polymer chain would lead to improved crystallinity at lower ethylene contents and thus a comparative absence of fluidity of solutions of these polymers used as motor oils at low temperatures.

The ethylene copolymers produced herein can be bimodal or multimodal. As used herein, a composition is “bimodal or multi modal” because it includes constituent polymer fractions which have different molecular weights, different molecular weight distributions, and/or different monomer compositional or sequence distributions. (By different is meant the property in question differs by at least 3%, preferably by at least 5%, preferably by at least 20%.) The polymerizations for making each constituent polymer fraction can be performed in parallel in two or more reactors and the effluent polymer solutions from each reactor are combined to form the bimodal polymer. The separate polymerizations may alternatively be performed in series, where the effluent of one reactor is fed to the next reactor.

In a preferred embodiment, the ethylene monomer is polymerized by a metallocene catalyst, to form a relatively low ethylene content polymer in one reactor and a relatively high ethylene content copolymer in another reactor. The combined is then subject to finishing to produce a solid, bimodal composition. The low ethylene component can be made first or the high ethylene component can be made first in a series reactor configuration or both components can be made simultaneously in a parallel reactor process.

Preferably, the bimodal polymer composition has a content of ethylene-derived units of from about 50 mole % to about 90 mole %. The solid bimodal polymer composition can also have a content of ethylene-derived units of from about 60 mole % to about 85 mole %, about 55 mole % to about 80 mole %, about 70 mole % to about 90 mole %, or about 65 mole % to about 85 mole %.

The alpha olefin can be present in the bimodal polymer composition in an amount of from about 5 mole % to about 45 mole %. The alpha olefin can also be present in the bimodal polymer composition in an amount of from about 10 mole % to about 40 mole %, about 15 mole % to about 35 mole %, about 20 mole % to about 30 mole %, about 25 mole % to about 45 mole %, or about 30 mole % to about 45 mole %.

In one or more embodiments, the ethylene polymer includes up to 5 mole % of one or more polyene-derived units, such as one or more dienes. The polyene content, if present, can range from a low of about 0.1 mole %, about 0.5 mole % or about 1.0 mole % to a high of about 3 mole %, about 4 mole %, or about 5 mole %. Also if present, the polyene content can be less than about 4 mole %, less than about 3 mole %, less than about 2 mole %, or less than about 1 mole %.

In another embodiment of this invention, the ethylene copolymer produced is bi- or multi-modal (on the SEC graph). By bi- or multi-modal means that the SEC graph of the polymer has two or more positive slopes, two or more negative slopes, and three or more inflection points (an inflection point is that point where the second derivative of the curve is equal to zero) or the graph has at least one positive slope, one negative slope, one inflection point, and a change in the positive and/or negative slope greater than 20% of the slope before the change.

The ethylene copolymers produced herein are preferably liquid at 23° C.

The ethylene copolymers produced herein preferably have an Mw of from 250 to 500,000 g/mol, preferably from 500 to 250,000 g/mol, preferably from 750 to 150,000 g/mol, preferably from 1000 to 120,000 g/mol.

The ethylene copolymers produced herein preferably have an Mn of from 250 to 500,000 g/mol, preferably from 500 to 250,000 g/mol, preferably from 750 to 150,000 g/mol, preferably from 1000 to 120,000 g/mol.

The ethylene copolymers produced herein preferably have an Mw/Mn of from >1 to 20 g/mol, preferably from 1.1 to 10 g/mol, preferably from 1.2 to 12 g/mol, preferably from 1000 to 120,000 g/mol.

The ethylene copolymers described herein can be used in base oil compositions and/or lubricating oil compositions. The base oil can be or include natural or synthetic oils of lubricating viscosity, whether derived from hydrocracking, hydrogenation, other refining processes, unrefined processes, or re-refined processes. The base oil can be or include used oil. Natural oils include animal oils, vegetable oils, mineral oils, and mixtures thereof. Synthetic oils include hydrocarbon oils, silicon-based oils, and liquid esters of phosphorus-containing acids. Synthetic oils may be produced by Fischer-Tropsch gas-to-liquid synthetic procedure as well as other gas-to-liquid oils.

In one embodiment, the base oil is or includes a polyalphaolefin (PAO) including a PAO-2, PAO-4, PAO-5, PAO-6, PAO-7 or PAO-8 (the numerical value relating to Kinematic Viscosity (cSt) at 100° C.). Preferably, the polyalphaolefin is prepared from dodecene and/or decene. Generally, the polyalphaolefin suitable as an oil of lubricating viscosity has a viscosity less than that of a PAO-20 or PAO-30 oil.

In one or more embodiments, the base oil can be defined as specified in the American Petroleum Institute (API) Base Oil Interchangeability Guidelines. For example, the base oil can be or include an API Group I, II, III, IV, V oil or mixtures thereof.

In one or more embodiments, the base oil can include oil or blends thereof conventionally employed as crankcase lubricating oils. For example, suitable base oils can include crankcase lubricating oils for spark-ignited and compression-ignited internal combustion engines, such as automobile and truck engines, marine and railroad diesel engines, and the like. Suitable base oils can also include those oils conventionally employed in and/or adapted for use as power transmitting fluids such as automatic transmission fluids, tractor fluids, universal tractor fluids, hydraulic fluids, heavy duty hydraulic fluids, power steering fluids, and the like. Suitable base oils can also be or include gear lubricants, industrial oils, pump oils, and other lubricating oils.

In one or more embodiments, the base oil can include not only hydrocarbon oils derived from petroleum, but also include synthetic lubricating oils such as esters of dibasic acids; complex esters made by esterification of monobasic acids, polyglycols, dibasic acids and alcohols; polyolefin oils, etc. Thus, the lubricating oil compositions described can be suitably incorporated into synthetic base oils such as alkyl esters of dicarboxylic acids, polyglycols and alcohols; polyalpha-olefins; polybutenes; alkyl benzenes; organic esters of phosphoric acids; polysilicone oils; etc. The lubricating oil composition can also be utilized in a concentrate form, such as from 1 wt % to 49 wt % in oil, e.g., mineral lubricating oil, for ease of handling, and may be prepared in this form by carrying out the reaction of the invention in oil, as previously described.

Lubricating oil/base oil compositions containing the ethylene copolymers described herein can optionally contain one or more conventional additives, such as, for example, pour point depressants, antiwear agents, antioxidants, other viscosity-index improvers, dispersants, corrosion inhibitors, anti-foaming agents, detergents, rust inhibitors, friction modifiers, and the like.

Corrosion inhibitors, also known as anti-corrosive agents, reduce the degradation of the metallic parts contacted by the lubricating oil composition. Illustrative corrosion inhibitors include phosphosulfurized hydrocarbons and the products obtained by reaction of a phosphosulfurized hydrocarbon with an alkaline earth metal oxide or hydroxide, preferably in the presence of an alkylated phenol or of an alkylphenol thioester, and also preferably in the presence of carbon dioxide. Phosphosulfurized hydrocarbons are prepared by reacting a suitable hydrocarbon, such as a terpene, a heavy petroleum fraction of a C₂ to C₆ olefin polymer, such as polyisobutylene, with from 5 wt % to 30 wt % of a sulfide of phosphorus for ½ to 15 hours, at a temperature in the range of 66° C. to 316° C. Neutralization of the phosphosulfurized hydrocarbon may be effected in the manner taught in U.S. Pat. No. 1,969,324, the disclosure of which is incorporated herein by reference.

Oxidation inhibitors, or antioxidants, reduce the tendency of mineral oils to deteriorate in service, as evidenced by the products of oxidation such as sludge and varnish-like deposits on the metal surfaces, and by viscosity growth. Such oxidation inhibitors include alkaline earth metal salts of alkylphenolthioesters having C₅ to C₁₂ alkyl side chains, e.g., calcium nonylphenate sulfide, barium octylphenate sulfide, dioctylphenylamine, phenylalphanaphthylamine, phosphosulfurized or sulfurized hydrocarbons, etc.

Other oxidation inhibitors or antioxidants useful in this invention include oil-soluble copper compounds, such as described in U.S. Pat. No. 5,068,047; the disclosure of which is incorporated herein by reference.

Friction modifiers serve to impart the proper friction characteristics to lubricating oil compositions, such as automatic transmission fluids. Representative examples of suitable friction modifiers are found in U.S. Pat. No. 3,933,659, which discloses fatty acid esters and amides; U.S. Pat. No. 4,176,074, which describes molybdenum complexes of polyisobutenyl succinic anhydride-amino alkanols; U.S. Pat. No. 4,105,571, which discloses glycerol esters of dimerized fatty acids; U.S. Pat. No. 3,779,928, which discloses alkane phosphonic acid salts; U.S. Pat. No. 3,778,375, which discloses reaction products of a phosphonate with an oleamide; U.S. Pat. No. 3,852,205, which discloses S-carboxyalkylene hydrocarbyl succinimide, S-carboxyalkylene hydrocarbyl succinamic acid and mixtures thereof; U.S. Pat. No. 3,879,306, which discloses N(hydroxyalkyl)alkenyl-succinamic acids or succinimides; U.S. Pat. No. 3,932,290, which discloses reaction products of di-(lower alkyl) phosphites and epoxides; and U.S. Pat. No. 4,028,258, which discloses the alkylene oxide adduct of phosphosulfurized N-(hydroxyalkyl) alkenyl succinimides. The disclosures of these references are incorporated by reference herein. Preferred friction modifiers are succinate esters, or metal salts thereof, of hydrocarbyl substituted succinic acids or anhydrides and thiobis-alkanols such as described in U.S. Pat. No. 4,344,853.

Dispersants maintain oil insolubles, resulting from oxidation during use, in suspension in the fluid, thus preventing sludge flocculation and precipitation or deposition on metal parts. Suitable dispersants include high molecular weight N-substituted alkenyl succinimides, the reaction product of oil-soluble polyisobutylene succinic anhydride with ethylene amines such as tetraethylene pentamine and borated salts thereof. High molecular weight esters (resulting from the esterification of olefin substituted succinic acids with mono or polyhydric aliphatic alcohols) or Mannich bases from high molecular weight alkylated phenols (resulting from the condensation of a high molecular weight alkylsubstituted phenol, an alkylene polyamine and an aldehyde such as formaldehyde) are also useful as dispersants.

Pour point depressants (“ppd”), otherwise known as lube oil flow improvers, lower the temperature at which the fluid will flow or can be poured. Any suitable pour point depressant known in the art can be used. For example, suitable pour point depressants include, but are not limited to, one or more C₈ to C₁₈ dialkylfumarate vinyl acetate copolymers, polymethyl methacrylates, alkylmethacrylates and wax naphthalene.

Foam control can be provided by any one or more anti-foamants. Suitable anti-foamants include polysiloxanes, such as silicone oils and polydimethyl siloxane.

Anti-wear agents reduce wear of metal parts. Representatives of conventional antiwear agents are zinc dialkyldithiophosphate and zinc diaryldithiosphate, which also serves as an antioxidant.

Detergents and metal rust inhibitors include the metal salts of sulphonic acids, alkyl phenols, sulfurized alkyl phenols, alkyl salicylates, naphthenates and other oil soluble mono- and dicarboxylic acids. Highly basic (viz, overbased) metal sales, such as highly basic alkaline earth metal sulfonates (especially Ca and Mg salts) are frequently used as detergents.

Compositions containing these conventional additives are typically blended into the base oil or lubricating oil in amounts which are effective to provide their normal attendant function. Thus, typical formulations can include, in amounts by weight, a VI improver (0.01-12%), a corrosion inhibitor (0.01-5%), an oxidation inhibitor (0.01-5%), depressant (0.01-5%), an anti-foaming agent (0.001-3%), an anti-wear agent (0.001-5%), a friction modifier (0.01-5%), a detergent/rust inhibitor (0.01-10%), and a base oil.

When other additives are used, it may be desirable, although not necessary, to prepare additive concentrates comprising concentrated solutions or dispersions of the viscosity index improver (in concentrate amounts hereinabove described), together with one or more of the other additives; such a concentrate denoted an “additive package,” whereby several additives can be added simultaneously to the base oil to form a lubricating oil composition. Dissolution of the additive concentrate into the lubricating oil may be facilitated by solvents and by mixing accompanied with mild heating, but this is not essential. The additive-package will typically be formulated to contain the viscosity index improver and optional additional additives in proper amounts to provide the desired concentration in the final formulation when the additive-package is combined with a predetermined amount of base lubricant. Thus, the products of the present invention can be added to small amounts of base oil or other compatible solvents along with other desirable additives to form additive-packages containing active ingredients in collective amounts of typically from 2.5% to 90%, preferably from 5% to 75%, and still more preferably from 8% to 50% by weight additives in the appropriate proportions with the remainder being base oil. The final formulations may use typically about 10 wt % of the additive-package with the remainder being base oil.

In at least one specific embodiment, the lubricating oil composition can include: one or more ethylene copolymers as described herein in an amount of from 0.1 wt % to 20 wt %, one or more base oils in an amount of from 1 wt % to 99 wt %, one or more dispersants in an amount of from 0.01 wt % to 25 wt %, and optionally one or more other additives in an amount of from 0.01 wt % to 20 wt %, based on total weight of the lubricating oil composition. Such weight percentages are based on the total weight of the oil composition.

In at least one specific embodiment, the lubricating oil composition can contain one or more ethylene copolymers as described herein in amounts of from 1.0 wt % to 20 wt %, 2.0 wt % to 18 wt %, 3.0 wt % to 15 wt %, 5 wt % to 14 wt %, or 5.0 wt % to 10 wt %. In one or more embodiments, the amount of one or more ethylene copolymers as described herein in the lubricating oil composition can range from a low of about 0.1 wt %, about 0.5 wt %, or about 1 wt % to a high of about 10 wt %, about 15 wt %, or about 20 wt %. In one or more embodiments, the amount of one or more ethylene copolymers as described herein in the lubricating oil composition can range from a low of about 0.1 wt %, about 2.0 wt %, or about 5 wt % to a high of about 12 wt %, about 17 wt %, or about 19 wt %. In one or more embodiments, the amount of one or more ethylene copolymers as described herein in the lubricating oil composition can be about 1 wt %, about 2 wt %, about 5 wt %, about 7 wt %, about 9 wt %, or about 10 wt %. In one or more embodiments, the amount of one or more ethylene copolymers as described herein in the lubricating oil composition can be about 0.5 wt %, about 0.6 wt %, about 0.7 wt %, about 0.8 wt %, about 0.9 wt %, about 1.0 wt %, about 1.2 wt %, about 1.4 wt %, about 1.6 wt %, about 1.8 wt %, or about 2.0 wt %. Such weight percentages are based on the total weight of the oil composition.

In at least one specific embodiment, the lubricating oil composition can contain one or more ethylene copolymers, as described herein, in an amount of from 0.5 wt % to 20 wt %, 1.0 wt % to 18 wt %, 3.0 wt % to 15 wt %, 5 wt % to 14 wt %, or 5.0 wt % to 10 wt %, and one or more base oils in an amount of from 1 wt % to 99 wt %, 50 wt % to 99 wt %, 53 wt % to 90 wt %, or 60 wt % to 90 wt %. When present, the amount of the ethylene copolymers as described herein in the oil compositions can be less than 10 wt %, less than 9 wt %, less than 8 wt %, less than 7 wt %, less than 6 wt %, less than 5 wt %, less than 4 wt %, less than 3 wt %, less than 2 wt %, less than 1 wt %, or less than 0.5 wt %, based on the total weight of the oil compositions. Such weight percentages are based on the total weight of the oil composition.

In at least one specific embodiment, the lubricating oil composition can contain one or more ethylene copolymers as described herein; one or more base oils in an amount of from 1 wt % to 99 wt %, 50 wt % to 99 wt %, 53 wt % to 90 wt %, or 60 wt % to 90 wt %, and one or more dispersants in an amount of from 0.5 wt % to 20 wt %, 1.0 wt % to 18 wt %, 3.0 wt % to 15 wt %, 5 wt % to 14 wt %, or 5.0 wt % to 10 wt %. When present, the amount of the ethylene copolymers, as described herein, in the oil compositions can be less than 10 wt %, less than 9 wt %, less than 8 wt %, less than 7 wt %, less than 6 wt %, less than 5 wt %, less than 4 wt %, less than 3 wt %, less than 2 wt %, less than 1 wt %, or less than 0.5 wt %. Such weight percentages are based on the total weight of the oil composition.

In at least one specific embodiment, the lubricating oil composition can contain one or more ethylene copolymers as described herein; one or more base oils in an amount of from 1 wt % to 99 wt %; 50 wt % to 99 wt %; 53 wt % to 90 wt %; or 60 wt % to 90 wt %; one or more dispersants in an amount of from 0.5 wt % to 20 wt %; 1.0 wt % to 18 wt %; 3.0 wt % to 15 wt %; 5 wt % to 14 wt %; or 5.0 wt % to 10 wt %; and one or more pour point depressants in an amount of from 0.05 wt % to 10 wt %; 0.7 wt % to 5 wt %; 0.75 wt % to 5 wt %; 0.5 wt % to 3 wt %; or 0.75 wt % to 3 wt %. When present, the amount of the ethylene copolymers, as described herein, in the oil compositions can be less than 10 wt %, less than 9 wt %, less than 8 wt %, less than 7 wt %, less than 6 wt %, less than 5 wt %, less than 4 wt %, less than 3 wt %, less than 2 wt %, less than 1 wt %, or less than 0.5 wt %. Such weight percentages are based on the total weight of the oil composition.

In any of the compositions described herein the ethylene copolymer may be a functionalized copolymer. The copolymers prepared herein may be functionalized by reacting a heteroatom containing group with the copolymer with or without a catalyst such as a hydrosilylation, hydroformylation, or hydroamination catalyst, or activators such as free radical generators (e.g., peroxides). The functionalized copolymers can be used in oil additivation and many other applications. Preferred uses include additives for lubricants and/or fuels. Preferred heteroatom containing groups include, amines, aldehydes, alcohols, acids, maleic acid, and maleic anhydride.

Alternately, if the ethylene copolymers have unsaturations available (either terminal or from comonomers), then these double bonds can be easily converted into functionalized fluids with multiple performance features. Examples for converting polymers can be found in the preparation of ashless dispersants, where the polymers are reacted with maleic anhydride to give PAO-succinic anhydride which can then be reacted with amines, alcohols, polyether alcohols, and converted into dispersants, detergents, or other functional additives. Examples for such conversion can be found in the book “Lubricant Additives:

Chemistry and Application,” ed. By Leslie R. Rudnick, Marcel Dekker, Inc. 2003, p. 143-170.

In some embodiments, the copolymers produced herein are functionalized as described in U.S. Pat. No. 6,022,929; A. Toyota, T. Tsutsui, and N. Kashiwa, Polymer Bulletin 48, 213-219, 2002; and J. Am. Chem. Soc., 1990, 112, 7433-7434.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

In another embodiment, this invention relates to:

1. An ethylene copolymer (preferably for lubricating oil), comprising (or alternately is the polymerized product of): (preferably comprising the polymerization product of): a) ethylene; b) at least one alpha-olefin having 3 or more carbon atoms; and c) at least one vicinally substituted olefin having 2 to 40 carbon atoms, wherein: the copolymer has a weight-average molecular weight (Mw) of about 50,000 to about 500,000; and an intensity ratio of S_{αβ} to S_{αα}, insertions, as determined by a ¹³C-NMR spectrum of less than 0.5.
2. The copolymer of paragraph 1, wherein the alpha-olefin is propylene and/or 1-butene.
3. The copolymer of paragraph 1 or 2, wherein the vicinally substituted olefin is disubstituted, and is preferably represented by the formula: (R¹)CH═CH(R²), where R¹ and R² independently comprise hydrocarbyl or silyl-hydrocarbyl groups containing one or more carbon or silicon atoms, preferably R¹ and R² comprise linear, branched, or cyclic substituted or unsubstituted hydrocarbyl groups comprising from 1 to 100 carbon or silicon atoms, and the vicinally substituted olefin does not include cyclic olefins wherein the olefinic group is entirely within a cyclic structure.
4. The copolymer of paragraph 3, wherein R¹ and R² comprise 30 or less carbon or silicon atoms or combinations thereof with the proviso that R¹ and R² comprise hydrocarbyl or silyl hydrocarbyl moieties.
5. The copolymer of paragraph 1 or 2, wherein the vicinally substituted olefin comprises cis or trans isomers of 2-butene, 2-pentene, 2-hexene, 3-hexene, 2-heptene, 3-heptene, 2-octene, 3-octene, 4-octene, 2-nonene, 3-nonene, 4-nonene, 2-decene, 3-decene, 4-decene, 5-decene, 2-undecene, 3-undecene, 4-undecene, 5-undecene, 2-dodecene, 3-dodecene, 4-dodecene, 5-dodecene, 6-dodecene, 4-methyl-2-pentene, 4-methyl-2-hexene, 5-methyl-2-hexene, 5-methyl-3-hexene, or 5 phenyl-2-hexene, derivatives thereof, or combinations thereof, preferably cis-2-butene or trans-2-butene, or a mixture thereof.
6. The copolymer of any of paragraphs 1 to 5, wherein the ethylene is present at about 50 mole % to about 90 mole %, preferably about 55 mole % to about 85 mole %, preferably about 60 mole % to about 80 mole %, alternately about 70 mole % to about 90 mole %, alternately about 65 mole % to about 85 mole %.
7. The copolymer of any of paragraphs 1 to 6, wherein the alpha-olefin is present in an amount of about 5 mole % to about 45 mole %, preferably about 10 mole % to about 40 mole %, preferably about 15 mole % to about 35 mole %, alternately about 20 mole % to about 30 mole %, alternately about 25 mole % to about 45 mole %.
8. The copolymer of any of paragraphs 1 to 7, wherein the copolymer is substantially free of geminally disubstituted olefins.
9. A lubricating oil composition comprising from 0.5 wt % to 15 wt %, based on the total weight of the lubricating oil composition, of the ethylene copolymer of any of paragraph 1 to 8 and from 60 wt % to 98 wt % of a base oil.
10. The lubricating oil composition of paragraph 9, further comprising from 0.1 wt % to 20 wt % of one or more dispersants.
11. The lubricating oil composition of paragraph 9 or 10, further comprising from 0.1 wt % to 10 wt % of one or more pour point depressants.
12. The lubricating oil composition of any of paragraphs 9 to 11, wherein the oil composition has a thickening efficiency of about 1.5 to about 2.5, wherein the thickening efficiency is defined as: TE=2/c×ln((kv of polymer+oil)/(kv of oil))/ln(2), where c is the concentration of the ethylene copolymer.
13. The lubricating oil composition of any of paragraphs 9 to 12, wherein the oil composition has a shear stability index of about 20 to about 60.
14. A process to produce the copolymer of any of paragraphs 1 to 8 comprising:

1) contacting a) ethylene; b) at least one alpha-olefin having 3 or more carbon atoms; and c) at least one vicinally substituted olefin having 2 to 40 carbon atoms, with a d) metallocene catalyst compound and an activator at a temperature of 100° C. or more; and

2) obtaining copolymer having a weight-average molecular weight (Mw) of about 50,000 to about 500,000; and an intensity ratio of S_{αβ} to S_{αα} insertions, as determined by a ¹³C-NMR spectrum of less than 0.5.

15. A process to produce the lubricating oil of any of paragraphs 9 to 13 comprising:

1) contacting a) ethylene; b) at least one alpha-olefin having 3 or more carbon atoms; and c) at least one vicinally substituted olefin having 2 to 40 carbon atoms, with a d) one or more metallocene catalyst compounds and an activator at a temperature of 100° C. or more; and

2) obtaining copolymer having a weight-average molecular weight (Mw) of about 50,000 to about 500,000; and an intensity ratio of S_{αβ} to S_{αα} insertions, as determined by a ¹³C-NMR spectrum of less than 0.5; and

3) combining 0.5 wt % to 15 wt %, based on the total weight of the lubricating oil composition, of the ethylene copolymer with 60 wt % to 98 wt % of a base oil.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An ethylene copolymer for lubricating oil, comprising, the polymerized product of:
ethylene;
at least one alpha-olefin having 3 or more carbon atoms; and
at least one vicinally substituted olefin having 2 to 40 carbon atoms, wherein:
the copolymer has a weight-average molecular weight (Mw) of about 50,000 to about 500,000; and
an intensity ratio of S_{αβ} to S_{αα} insertions, as determined by a ¹³C-NMR spectrum of less than 0.5.

2. The copolymer of claim 1, wherein the vicinally substituted olefin is disubstituted.

3. The copolymer of claim 1, wherein the ethylene is present in an amount of from about 50 mole % to about 90 mole %.

4. The copolymer of claim 1, wherein the alpha-olefin is present in an amount of from about 5 mole % to about 45 mole %.

5. The copolymer of claim 1, wherein the ethylene is present in an amount of from about 30 mole % to about 45 mole %.

6. The copolymer of claim 1, wherein the at least one vicinally substituted olefin is described by the general formula: (R¹)CH═CH(R²), where R¹ and R² independently comprise hydrocarbyl or silyl-hydrocarbyl groups containing one or more carbon or silicon atoms.

7. The copolymer of claim 6, wherein the R¹ and R² comprise linear, branched, or cyclic substituted or unsubstituted hydrocarbyl groups comprising from 1 to 100 carbon or silicon atoms, wherein the at least one vicinally substituted olefin does not include cyclic olefins wherein the olefinic group is entirely within a cyclic structure.

8. The copolymer of claim 6, wherein the R¹ and R² comprise 30 or less carbon or silicon atoms or combinations thereof with the proviso that R¹ and R² comprise hydrocarbyl or silyl hydrocarbyl moieties.

9. The copolymer of claim 6, wherein the R¹ and R² additionally comprise non-carbon or non-silicon atoms selected from the group consisting of B, O, S, Se, Te, N, P, Ge, Sn, Pb, As, F, Cl, Br, and I.

10. The copolymer of claim 1, wherein the vicinally substituted olefin comprises cis or trans isomers of 2-butene, 2-pentene, 2-hexene, 3-hexene, 2-heptene, 3-heptene, 2-octene, 3-octene, 4-octene, 2-nonene, 3-nonene, 4-nonene, 2-decene, 3-decene, 4-decene, 5-decene, 2-undecene, 3-undecene, 4-undecene, 5-undecene, 2-dodecene, 3-dodecene, 4-dodecene, 5-dodecene, 6-dodecene, 4-methyl-2-pentene, 4-methyl-2-hexene, 5-methyl-2-hexene, 5-methyl-3-hexene, or 5 phenyl-2-hexene, derivatives thereof, or combinations thereof.

11. The copolymer of claim 1, wherein the at least one vicinally substituted olefin comprises cis-2-butene or trans-2-butene, or a mixture thereof.

12. The copolymer of claim 1, wherein the least one alpha-olefin propylene or 1-butene.

13. The copolymer of claim 1, wherein the copolymer is substantially free of geminally disubstituted olefins.

14. A lubricating oil composition comprising, the polymerized product of:
of from about 0.5 wt % to about 15 wt %, based on the total weight of the lubricating oil composition, an ethylene copolymer comprising:
ethylene;
at least one alpha-olefin having 3 or more carbon atoms; and
at least one vicinally substituted olefin having 2 to 40 carbon atoms, wherein:
the copolymer has a weight-average molecular weight (Mw) of about 50,000 to about 500,000; and
a ratio of S_{αβ} to S_{αα} insertions, as determined by a ¹³C-NMR spectrum of less than 0.5; and
of from about 60 wt % to about 98 wt %, based on the total weight of the lubricating oil composition, a base oil.

15. The lubricating oil composition of claim 14, further comprising of from about 0.1 wt % to about 20 wt %, based on the total weight of the lubricating oil composition, one or more dispersants.

16. The lubricating oil composition of claim 14, further comprising of from about 0.1 wt % to about 10 wt %, based on the total weight of the lubricating oil composition, one or more pour point depressants.

17. The lubricating oil composition of claim 14, wherein the oil composition has a thickening efficiency of about 1.5 to about 2.5, wherein the thickening efficiency is defined as:
TE=2/c×ln((kv of polymer+oil)/(kv of oil))/ln (2)
where c is the concentration of the ethylene copolymer.

18. The lubricating oil composition of claim 14, wherein the oil composition has a shear stability index of about 20 to about 60.

19. The lubricating oil composition of claim 14, wherein the ethylene is present in an amount of from about 50 mole % to about 90 mole %, based on total weight of the ethylene copolymer, and the alpha olefin is present in an amount of from about 5 mole % to about 45 mole %.

20. The lubricating oil composition of claim 14, wherein the at least one vicinally substituted olefin is described by the general formula: (R¹)CH═CH(R²), where R¹ and R² independently comprise hydrocarbyl or silyl-hydrocarbyl groups containing one or more carbon or silicon atoms.

21. The lubricating oil composition of claim 14, wherein the vicinally substituted olefin comprises cis or trans isomers of 2-butene, 2-pentene, 2-hexene, 3-hexene, 2-heptene, 3-heptene, 2-octene, 3-octene, 4-octene, 2-nonene, 3-nonene, 4-nonene, 2-decene, 3-decene, 4-decene, 5-decene, 2-undecene, 3-undecene, 4-undecene, 5-undecene, 2-dodecene, 3-dodecene, 4-dodecene, 5-dodecene, 6-dodecene, 4-methyl-2-pentene, 4-methyl-2-hexene, 5-methyl-2-hexene, 5-methyl-3-hexene, or 5 phenyl-2-hexene, derivatives thereof, or combinations thereof.

22. The lubricating oil composition of claim 14, wherein the at least one vicinally substituted olefin comprises cis-2-butene or trans-2-butene, or a mixture thereof.

23. The lubricating oil composition of claim 14, wherein the alpha-olefin is propylene or 1-butene.

24. A process to produce an ethylene copolymer comprising:
1) contacting a) ethylene; b) at least one alpha-olefin having 3 or more carbon atoms; and c) at least one vicinally substituted olefin having 2 to 40 carbon atoms, with d) one or more metallocene catalyst compounds and an activator at a temperature of 100° C. or more; and
2) obtaining ethylene copolymer having a weight-average molecular weight (Mw) of about 50,000 to about 500,000; and an intensity ratio of S_{αβ} to S_{αα} insertions, as determined by a ¹³C-NMR spectrum of less than 0.5.

25. A process to produce a lubricating oil comprising:
1) contacting a) ethylene; b) at least one alpha-olefin having 3 or more carbon atoms; and c) at least one vicinally substituted olefin having 2 to 40 carbon atoms, with d) one or more metallocene catalyst compounds and an activator at a temperature of 100° C. or more; and
2) obtaining an ethylene copolymer having a weight-average molecular weight (Mw) of about 50,000 to about 500,000; and an intensity ratio of S_{αβ} to S_{αα} insertions, as determined by a ¹³C-NMR spectrum of less than 0.5; and
3) combining 0.5 wt % to 15 wt %, based on the total weight of the lubricating oil composition, of the ethylene copolymer with 60 wt % to 98 wt % of a base oil.
